(19) United States
(12) Patent Application Publication
(10) Pub. No.: US 2019/0287158 A1
(43) Pub. Date: Sep. 19, 2019

(54) RAPID SERVICE DELIVERY

(71) Applicant: Venminder, Inc., Elizabethtown, KY (US)

(72) Inventor: Dana A. Bowers, Elizabethtown, KY (US)

(21) Appl. No.: 16/353,085

(22) Filed: Mar. 14, 2019

Related U.S. Application Data
(60) Provisional application No. 62/644,311, filed on Mar. 16, 2018.

(51) Int. Cl. G06Q 30/06; G06F 9/451; H04L 29/06

(52) U.S. Cl. CPC G06Q 30/0635; G06F 3/04842; H04L 63/102; G06F 9/451

(57) ABSTRACT

Methods and systems are presented herein for managing contracts between a financial institution and its vendors, assessing risk associated with a vendor providing services and/or other products to a financial institution, and for managing related services provided to a financial institution by a service provider.

### RELATED APPLICATIONS

The present application claims the benefit of U.S. Provisional Patent Application Ser. No. 62/644,311, filed on Mar. 16, 2018, titled “Rapid Service Delivery”, the disclosure of which is incorporated herein by reference in its entirety.

### FIELD OF THE INVENTION

This invention relates generally to systems and methods for managing client/vendor relationships. More particularly, in certain embodiments, the invention relates to systems and methods for providing certain services for vendor management.

### BACKGROUND

Financial institutions such as banks and credit unions are increasingly relying on third-party vendors to perform various important functions. While this improves efficiency and reduces cost for the financial institution, there are various risks posed by such outsourcing. A financial institution (“FI”) must establish a vendor oversight program to mitigate such risks, comply with various regulations, and pass examination by auditors. Generally, maintaining oversight of different vendors and vendor products requires a coordination of large amounts of oversight requirements, tasks, documents, results, due dates, and individuals.

### SUMMARY

Example methods and systems are presented herein for managing contracts between a financial institution and its vendors, assessing risk associated with a vendor providing services and/or other products to a financial institution, and for managing related services provided to a financial institution by a service provider.

In one aspect, the invention is directed to a computer implemented method for managing service orders relating to contracts between a financial institution and its vendors. An example method comprises the steps of: causing to display, by a processor of an enterprise system, a first graphical user interface (GUI) associated with a rapid service delivery module; receiving, by the processor, a first input from a first client user (e.g., said first client user having been authorized to access the enterprise system, e.g., said first client user being one member of a network of subscribed clients), the first input comprising instructions to select the rapid service delivery module; causing to display, by a processor, a second GUI associated with one or more service products; receiving, by the processor, a second input from the first client user, the second input comprising instructions to select one of the one or more services, thereby placing an order for the one of the one or more services; and updating, in a memory of the enterprise system, information relating to the selected service product in association with the first client, based on the second input.

In some implementations, the method comprises causing to display, by the processor, a workspace GUI (e.g., an attach documents dialog window GUI), wherein a subsequent input comprises custom data field information, the custom data field information comprising information relating to one or more selectable electronic files; receiving, by the processor, custom data filed information relating to the one or more selectable electronic files thereby selecting one of the one or more selectable files; and transferring, by the processor, the one or more selected electronic files from a client user device to the enterprise system.

In some implementations, the method comprises causing to display, by the processor, a workspace GUI (e.g., a verify services by vendor GUI), wherein a subsequent input comprises instructions to initiate an order verification process or a cancellation process.

In some implementations, the method comprises causing to display, by the processor, upon instruction (e.g., by clicking a button on a GUI) by a user to initiate an order verification process of an order, a workspace GUI (e.g., a complete order verification GUI), wherein a subsequent input comprises instructions to complete an order verification process.

In some implementations, the method comprises causing to display, by the processor, upon instruction (e.g., by clicking a button on a GUI) by a user to cancel an order, a workspace GUI (e.g., a confirm action to cancel GUI), wherein a subsequent input comprises instructions to cancel a service process.

In some implementations, the method comprises causing to display, by the processor, a workspace GUI (e.g., an order history GUI), wherein a subsequent input comprises instructions to open a workspace to input custom data field information, the custom data field information relating to additional information required to process an order.

In some implementations, the method comprises causing to display, by the processor, a workspace GUI (e.g., attention required dialog widget), wherein a subsequent input comprises custom data field information, the custom data field information comprising file information; receiving, by the processor, custom data filed information relating to one or more selected electronic files; and transferring, by the processor, the one or more selected electronic files from a client user device to the enterprise system.

In some implementations, the method comprises causing to display, by the processor, a workspace GUI (e.g., view document collection deliverables window GUI), wherein a subsequent input comprises, upon completion of an order, instructions to open a workspace to download one or more electronic documents from the enterprise system to a client computing device.

### BRIEF DESCRIPTION OF THE FIGURES

FIG. 1 is a block diagram of an example system for managing contracts between a financial institution and its vendors.

FIG. 2 is a block diagram of the example system for managing contracts between the financial institution and its vendors in accordance with an embodiment of the invention.

FIG. 3 is a flow diagram of an example rapid service delivery workflow in accordance with an embodiment of the invention.

FIG. 4 is an example of a client support—service settings workspace in accordance with an embodiment of the invention.

FIG. 5 is an example of a service portal access options widget in accordance with an embodiment of the invention.

FIG. 6 is an example of a software menu—options for services widget in accordance with an embodiment of the invention.

FIG. 7 is an example of an admin panel—manage service roles workspace in accordance with an embodiment of the invention.

FIG. 8 is an example of a new header icons displayed in the rapid service delivery module in accordance with an embodiment of the invention.

FIG. 9 is an example of a dialog for contracted vs. available services workspace in accordance with an embodiment of the invention.

FIG. 10 is an example of a dialog to review order workspace and window in accordance with an embodiment of the invention.

FIG. 11 is an example of a dialog for current status of funds widget in accordance with an embodiment of the invention.

FIG. 12 is an example of a rapid service delivery module landing workspace in accordance with an embodiment of the invention.

FIG. 13 is an example of an order vendor-level service workspace in accordance with an embodiment of the invention.

FIG. 14A is an example of an order contract summary for software (single contract) workspace in accordance with an embodiment of the invention.

FIG. 14B is an example of an order contract summary for software (multiple contracts) workspace in accordance with an embodiment of the invention.

FIG. 14C is an example of an order contract summary for software (no contract) workspace in accordance with an embodiment of the invention.

FIG. 14D is an example of an order contract summary for services only workspace in accordance with an embodiment of the invention.

FIG. 15 is an example of an order product-level service workspace in accordance with an embodiment of the invention.

FIG. 16 is an example of an attach documents dialog window in accordance with an embodiment of the invention.

FIG. 17 is an example of a display all available services workspace in accordance with an embodiment of the invention.

FIG. 18 is an example of an information request workspace in accordance with an embodiment of the invention.

FIG. 19 is an example of a review order workspace in accordance with an embodiment of the invention.

FIG. 20 is an example of an edit order (via review order) page in accordance with an embodiment of the invention.

FIG. 21 is an example of an orders in other users' carts workspace in accordance with an embodiment of the invention.

FIG. 22 is an example of a confirm order submission widget in accordance with an embodiment of the invention.

FIG. 23 is an example of an order verification workspace in accordance with an embodiment of the invention.

FIG. 24 is an example of a fulfillment vendor entry workspace in accordance with an embodiment of the invention.

FIG. 25 is an example of a verify services by vendor workspace in accordance with an embodiment of the invention.

FIG. 26 is an example of a service details display in accordance with an embodiment of the invention.

FIG. 27 is an example of a confirm order verification (dialog to confirm action to verify service) widget in accordance with an embodiment of the invention.

FIG. 28 is an example of a modal to confirm action to cancel service item widget in accordance with an embodiment of the invention.

FIG. 29 is an example of an order verification—add service widget in accordance with an embodiment of the invention.

FIG. 30 is an example of an order history by order landing workspace in accordance with an embodiment of the invention.

FIG. 31 is an example of an order history status indicator widget in accordance with an embodiment of the invention.

FIG. 32 is an example of a cancel pending order (dialog to confirm order cancellation) widget in accordance with an embodiment of the invention.

FIG. 33 is an example of an order details workspace in accordance with an embodiment of the invention.

FIG. 34 is an example of an order history by item workspace in accordance with an embodiment of the invention.

FIG. 35 is an example of an attention required dialog widget in accordance with an embodiment of the invention.

FIG. 36 is an example of a future dated item (manage date for future-dated item) widget in accordance with an embodiment of the invention.

FIG. 37 is an example of an order history—complete analysis window in accordance with an embodiment of the invention.

FIG. 38 is an example of an order history—view interval service deliverables window in accordance with an embodiment of the invention.

FIG. 39 is an example of an order history—view document collection deliverables window in accordance with an embodiment of the invention.

FIG. 40 is an example of an order history—view package deliverables window in accordance with an embodiment of the invention.

FIG. 41 is an example of a place order—reorder required dialog widget in accordance with an embodiment of the invention.

FIG. 42 is an example of a reorder ongoing service workspace in accordance with an embodiment of the invention.

FIG. 43 is an example of a client—my account workspace accordance with an embodiment of the invention.

FIG. 44 is an example of a flex statement dialog window in accordance with an embodiment of the invention.

FIG. 45A is an example of a due diligence rating widget (client has the selected vendor product in their vendor list) in accordance with an embodiment of the invention.

FIG. 45B is an example of a due diligence rating widget (client does not have the selected vendor product in their vendor list) in accordance with an embodiment of the invention.

FIG. 45C is an example of a due diligence rating widget (client receives the option to submit to Support a services request) in accordance with an embodiment of the invention.

FIG. 46 is a block diagram of an example network environment for use in the methods and systems described herein, according to an illustrative embodiment.

FIG. 47 is a block diagram of an example computing device and an example mobile computing device, for use in illustrative embodiments of the invention.

Like reference numerals in the figures indicate like elements.

### DETAILED DESCRIPTION

The vendor management process has historically been disjointed, messy, and time-consuming. A single financial institution may have numerous vendors to manage, and there may be many individuals within a given financial institution who deal with a given vendor and must coordinate collection of documents and data regarding the corresponding vendor products. Furthermore, the terms of various contracts between a financial institution and its vendors must be carefully monitored.

Moreover, financial institutions may wish to maintain different types of information about the vendors and vendor products with which they are associated. Traditional vendor management systems allow financial institutions to maintain information according to a predetermined set of fields.

There is a need for a consolidated, efficient system for managing contracts between a financial institution and its vendors and for preparation of associated vendor oversight reports which include specific risk assessment information for each vendor. There is also a need for customizable vendor profiles that allow new fields of information to be maintained for each vendor. Moreover, there is a need for providing oversight management in a way that information about vendors, products, tasks, results, due dates, and the like can be centrally viewed, updated and output to compliance officers, board members and others. Methods and systems are presented herein for assessing risk associated with a vendor providing services and/or other products to a financial institution, for preparation of associated risk assessment reports or vendor oversight reports, and for maintenance of a plurality of risk assessment reports associated with a plurality of vendors. Methods and systems are presented herein for managing and delivering related services to one or more client users.

A system for managing and delivering services to assist financial institutions to manage vendors can include a rapid service delivery (RSD) feature set that allows users (e.g., client users) of a system to order certain services, e.g., provided by the system provider, via an application, e.g., an application that is or includes one or more graphical user interfaces. The RSD feature may be a stand-alone solution or integrated into another system, e.g., a vendor management system. Clients that have system provider services as part of their purchase plan may be able to access this feature to submit and manage their service orders. In some implementations, services may be provided by the system provider. In some implementations, services may be provided by an entity different from the system provider. Additionally, client users may be given the possibility to manage their (individual) users and grant permission to submit orders only to those with authority to purchase services, and manage budgets or funds for service through the RSD feature. Client users may begin with a balance of funds that may be used to submit service orders.

Orders that are submitted can be verified, e.g., directly (e.g., automatically) by the system or through input by a support team of the system provider. Orders may undergo a workflow to submit work to subject matter experts for review and delivery back to the client user. As part of the workflow, the system provider may link a client user's vendor products to a so-called fulfillment vendor, e.g., a vendor that has already been analyzed by the system provider. The link between the client's vendor and a fulfillment vendor can identify existing work, resulting in a shorter turnaround period for service delivery to the client.

A client user whose purchase plan specifies both software and services may have access to the provider's vendor management system application, e.g., a web based application, as well as the rapid service delivery system as described herein. Client users who are classified as services-only may only have access to the rapid service delivery system/feature.

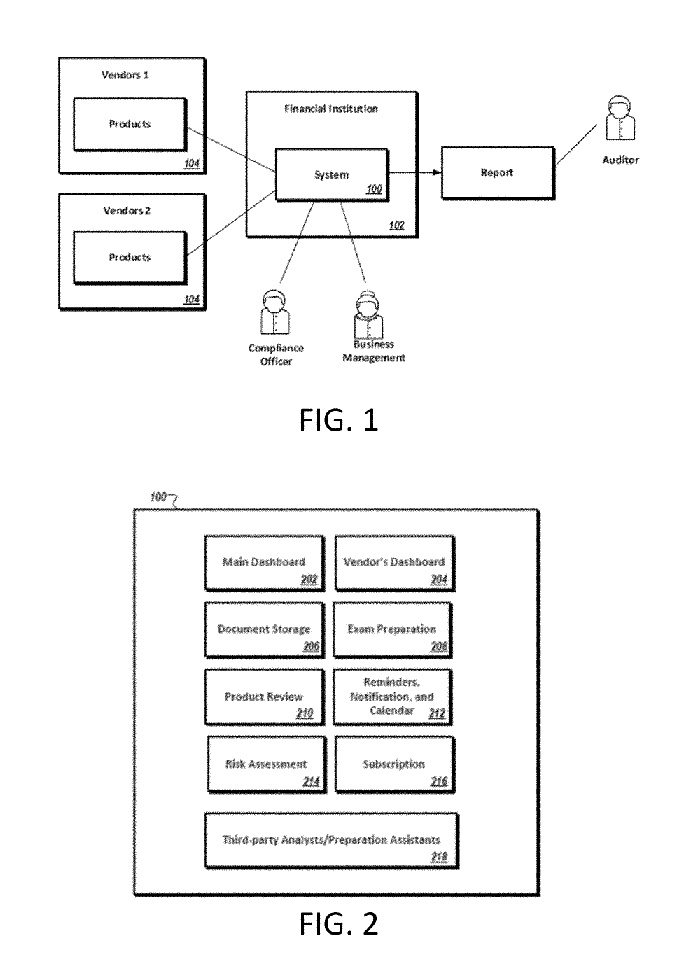

FIG. 1 is a block diagram of an example system 100, e.g., a provider's vendor management system, to assist financial institutions 102 to manage vendors 104 in accordance with an embodiment of the invention. In some implementations, the system 100 provides guided workflow to i) manage contracts with a given vendor 104, to provide a guided workflow to assist the financial institution 102 to prepare for a compliance or contract audit examination, ii) provide a rating system of the vendors 104 and their products and services, iii) provide a risk-assessment rating-system for the vendors 104, and iv) provide mechanisms for collaboration, the tracking of communication, and document storage.

FIG. 2 is a block diagram of the example system 100 for managing contracts between the financial institution and its vendors in accordance with an embodiment of the invention. The system 100 may include a main dashboard 202 for managing actions associated with a given vendor 104 and to track such actions. The system 100 may include a vendor dashboard 204 to view and manage products and vendors associated with a given financial institution. The system 100 may include a document storage page 206 to view and manage documents associated with the vendors and their products. In some implementations, the document storage page 206 may be accessible via the main dashboard 202 and the vendor dashboard 204.

The system 100 may include a reminder, notification, and/or calendar function 212. The function 212 may manage and store a list of dates associated with expiration of a given document or contract as well as a list of personal reminders provided by the end-users. The function 212 may display such reminders in a calendar display. The function 212 may send notifications to the end-user based on pre-defined rules associated with an examination. The rules may be related to the expiration date of a given product or agreement, a scheduled examination, a risk-assessment evaluation, etc.

The function 212 may include an alert and/or information feed (e.g., new documents uploaded, new reviews added, status update on a given examination or preparation process, etc.). The alert may include a progress bar to indicate a given end-user progress with a given task. The alert may include an experience bar to indicate a given end-user usage level associated with the various functions of the system 100.

The system 100 may include a risk-assessment module 214 to guide an end-user in assigning a risk rating for a given vendor and/or product. The risk-rating may be utilized as part of the reporting of the compliance and/or contract audit examination. In some implementations, the risk rating may be used to determine the types of information and the types of documents to include in the examination report.

The system 100 may include a subscription module 216. The subscription module 216 may manage and maintain usage by the end-user of the various system components (e.g., 202, 204, 206, 208, 210, 212, and 214) for a given financial institution. The system 100 may monitor the end-user's action, such as the usage of complimentary tools and document storage, purchases of additional tools and document storage, purchases of enterprise features, among others.

In some example embodiments, the system may include one or more modules for executing, providing and/or causing to display one or more graphical user interfaces (GUIs) and/or widgets. The GUIs and/or widgets may include vendor profile widgets for, among other things, managing vendor profiles; oversight grid widgets for, among other things, providing grid-based oversight of oversight requirements; task widgets for, among other things, managing tasks associated with oversight requirements; oversight management widgets for, among other things, managing tasks and oversight requirements associated with vendors and/or vendor products; document widgets for, among other things, managing documents associated with tasks; administrator widgets for, among other things, managing users; dashboard widgets for, among other things, managing outstanding tasks and vendor products associated with users; and reports widgets for, among other things, generating status, task and/or vendor reports.

In some example embodiments, data associated with vendors (e.g., vendor management information), which is used by the GUIs and/or widgets, may be stored in a memory of the system 100 or of a client computing device associated with the system 100. In some example embodiments, the system 100 is an enterprise system with which one or more enterprise client computing devices are connected.

Example vendor management systems and methods that can be used in combination with the technologies described herein are described in detail, e.g., in U.S. patent application Ser. No. 14/225,217, titled “Systems and Methods for Managing Contracts between a Financial Institution and its Vendors,” filed Mar. 25, 2014, U.S. patent application Ser. No. 15/086,954, titled “Systems and Methods, for Automated Management of Contracts between Financial Institutions and Vendors, Automated Preparation of Examination Reports, and Automated Management of Examination Reports,” filed Mar. 31, 2016, U.S. patent application Ser. No. 15/241,338, titled “Systems and Methods for Providing Vendor Management and Custom Profiles,” filed Aug. 19, 2016, and U.S. patent application Ser. No. 15/796,221, titled “Systems and Methods for Providing Vendor Management, Risk Assessment, Due Diligence, and Custom Profiles,” filed Oct. 27, 2017, the disclosure of each of which is incorporated herein by reference in its entirety.

In some example embodiments, the system 100 may include one or more interfaces or links that allow a user to access a rapid service delivery module. Any type of service applicable to financial institutions and/or their vendors may be provided. In some embodiments, an executive level analysis is a service provided, e.g., by the provider of the system 100, e.g., where the system provider's team of Certified Information Systems Security Professionals (CISSPs) and/or Certified Public Accountants (CPAs) perform a qualified review and analysis of due diligence documentation (e.g., financial statements, results of lien searches, IT security analyses). Alternatively or additionally, the executive level analysis may be performed by one or more third parties. When the review and analysis are complete, a summary and overall review result can be delivered to the client requesting the service, e.g., via a due diligence rating module and/or widget.

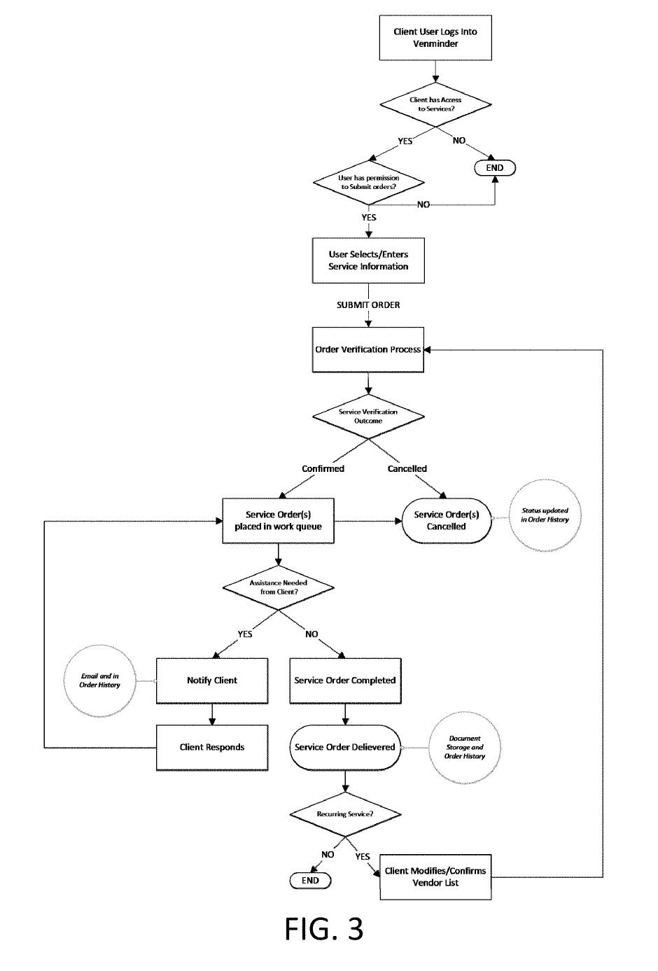

FIG. 3 is a flow diagram of an example rapid service delivery workflow in accordance with an embodiment of the invention. After a client user logs into a system, e.g., system 100, e.g., by entering and/or transmitting identifying information, e.g., via a graphical user interface (GUI), it may be determined, by the system, if the client user has access to services, e.g., provided through a rapid service delivery system. If affirmative, it may be determined, by the rapid service delivery system, if a client user, e.g., an individual client user, has permission to submit orders. If affirmative, the client user may be presented, by the rapid service delivery system, with a GUI to select or enter service information and to submit an order to the system. The order may be verified, e.g., by the rapid service delivery system, e.g., by executing a verification program. The verification process may produce a service verification outcome. If the outcome is negative, the service order may be cancelled. If the outcome is affirmative, the order may be confirmed, and the service order may be placed in a work queue. It may be determined, e.g., by the rapid service delivery system, e.g., by executing an analysis program, if assistance from client user is required. If affirmative, the client may be notified, e.g., by the rapid service delivery system, e.g., via an email or other message generated by the rapid service delivery system. The client user may then respond, e.g., by entering additional information into an appropriate GUI or widget provided by the rapid service delivery system, and the additional information may be added to the service order in the work queue. If assistance from client user is not required, the service order may be completed, e.g., by the rapid service delivery system executing an appropriate program. The service order may be delivered to the client user, e.g., by the rapid service delivery system, e.g., via email or electronic download. It may be determined, e.g., by the rapid service delivery system, e.g., by executing an appropriate program, if the service is a recurring service. If affirmative, the client user may be presented, by the rapid service delivery system, with a GUI to modify and/or confirm a vendor list.

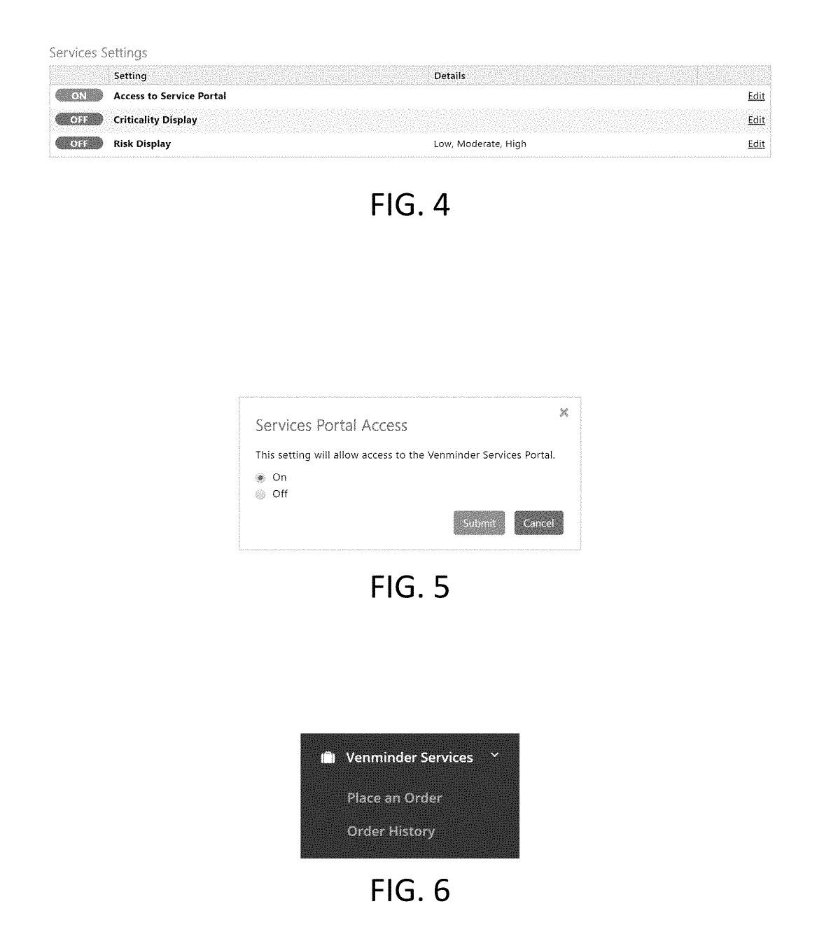

FIG. 4 is an example of a client support—service settings workspace in accordance with an embodiment of the invention. An example system 100 can manage a client user's access to rapid service delivery, e.g., through client support (system admin user experience). If a client user has access to services only, the support team can also make available, e.g., on the client support—service settings workspace, the option to designate criticality and risk ratings to their vendor products, e.g., by editing access settings.

FIG. 5 is an example of a service portal access options widget in accordance with an embodiment of the invention. If the access to services portal setting is set to On, then a client user at an institution can see the rapid service delivery module in their navigation menus. If set to Off, then navigation to those pages are not available in a client user menu.

FIG. 6 is an example of a software menu—options for services widget in accordance with an embodiment of the invention. Navigation to the rapid service delivery module portal (e.g., via a main dashboard menu or header menu) may be visible to client users whose purchase plan includes one or more services eligible for in-app ordering. The services settings in system admin or provider admin client support must also be set to On.

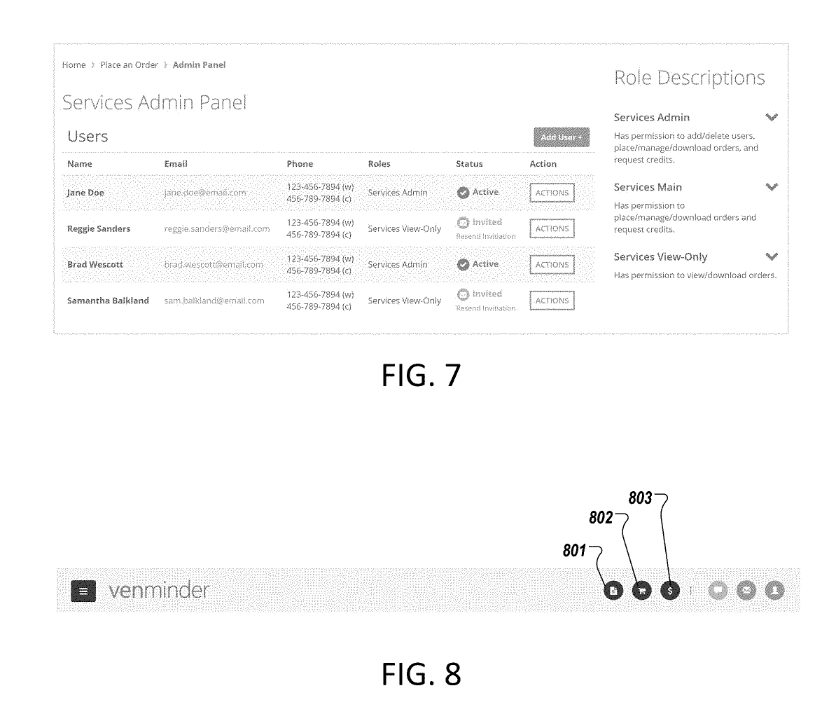

FIG. 7 is an example of an admin panel—manage service roles workspace in accordance with an embodiment of the invention. New client user roles may be available in the client user's admin panel to manage permissions and access to a rapid service delivery (RSD) module. These roles can be as follows: Services admin—User has the authority to manage user and submit/manage orders. Services main—User has the authority to submit and manage orders. Services view-only—User has access to RSD but can only view/download deliverables.

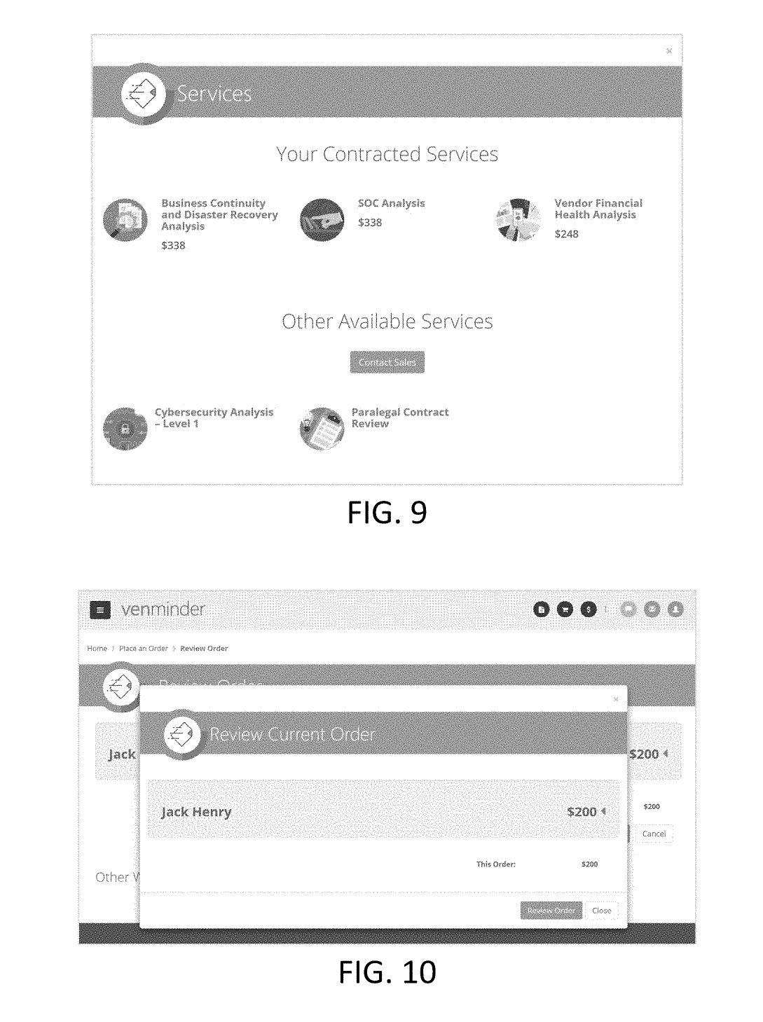

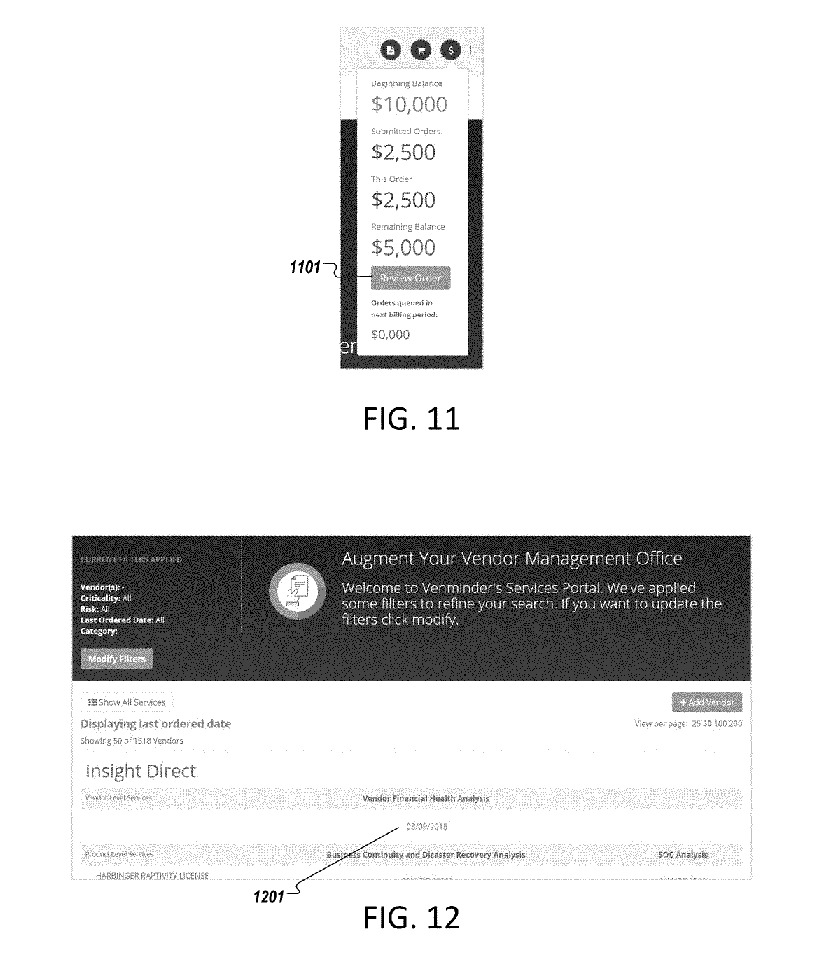

A client user may access a rapid service delivery module as described herein. FIG. 8 is an example of new header icons displayed in the rapid service delivery module in accordance with an embodiment of the invention. The header may contain additional options while in the rapid service delivery module portal. Clicking on the document icon 801 may display contracted services vs. available services. Users may have the opportunity to contact sales for available services: FIG. 9 is an example of a dialog for contracted vs. available services workspace in accordance with an embodiment of the invention. Clicking on the cart icon 802 may display total costs for any services queued up for submission, at the user level, e.g., to allow a user to review one or more orders: FIG. 10 is an example of a dialog to review order workspace and window in accordance with an embodiment of the invention. Clicking the ($) icon 803 may display the client current fund status. This may indicate a client user's current available balance, value of orders already submitted, value of an order currently in the user's cart, and/or the estimated available remaining balance. FIG. 11 is an example of a dialog for current status of funds widget in accordance with an embodiment of the invention. In some implementations, if there are orders submitted to a future date beyond the current billing period, this may be noted in the lower area of the dialog. From this view, a client user may click the review order button 1101 to review an order currently in the cart and submit the order for work.

FIG. 12 is an example of a rapid service delivery module landing workspace in accordance with an embodiment of the invention. Upon access to the rapid service delivery module, e.g., provided by a rapid service delivery system, a client user may be presented with a grid for all active vendors, listed in alphabetical order. For each vendor, the grid may display available services at the vendor and product level services. A vendor service may be a service that relates to a certain vendor, for example document review pertaining to a selected vendor. In some implementations, said documentation may be documentation that is shared among all products of said vendor. A product level service may be a service that relates only to one or more products of a vendor. Date 1201 may represent the last date a service was ordered for that vendor or product. If no service was previously ordered, then the date may be displayed as MM/DD/YYYY. The date display may comprise a link. In some implementations, when a user hovers the mouse pointer over the date, a widget with an automatically generated message may be displayed. In some implementations, the message may read “Order Now, or Reorder.” In some implementations, a client user may not be able to order in the event that an order is in another client user's cart, future dated, pending verification, or in progress. In some implementations, clicking an appropriate button on the widget to order or reorder will open a dialog requesting order information for the selected service.

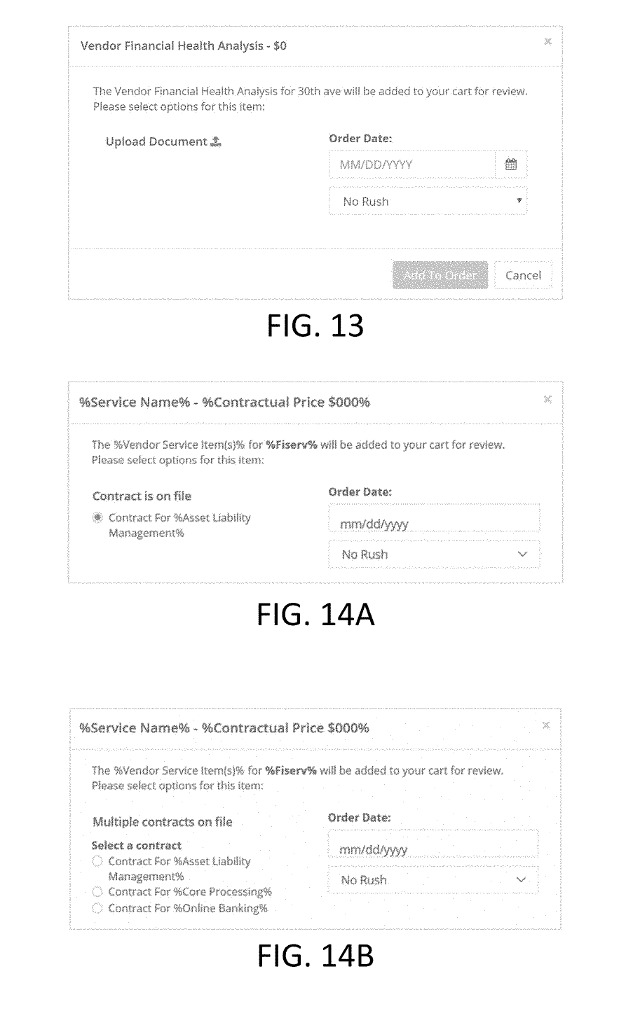

A client user may order one or more services, e.g., a financial health analysis of a vendor, as described herein. FIG. 13 is an example of an order vendor-level service workspace in accordance with an embodiment of the invention. In some implementations, vendor-level services may provide to a client user an option to attach documentation for review, select an order date, and/or any rush elections by uploading a document from a computing device of a client user, and/or by entering the appropriate information on the widget.

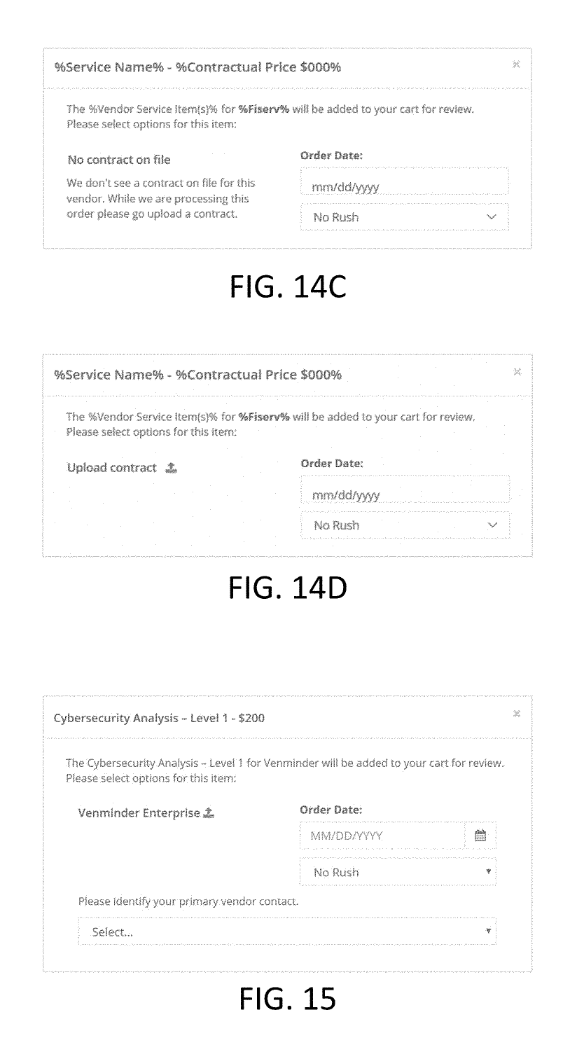

A client user may order one or more contract summary services as described herein. FIG. 14A is an example of an order contract summary for software (single contract) workspace in accordance with an embodiment of the invention. Contract Summary services may take into consideration whether the client has access to a contract management software package and/or if there is a contract on file.

FIG. 14B is an example of an order contract summary for software (multiple contracts) workspace in accordance with an embodiment of the invention. If the rapid service delivery system identified multiple contracts for the vendor, the client may be required to select which contract is to be reviewed, e.g., by clicking on the appropriate radio button on the workspace.

FIG. 14C is an example of an order contract summary for software (no contract) workspace in accordance with an embodiment of the invention. In some implementations, a client user may still be able to submit a contract summary order if the rapid service delivery system did not identify a contract match. In some implementations, the contract summary service cannot be completed until a contract is uploaded and processed.

FIG. 14D is an example of an order contract summary for services only workspace in accordance with an embodiment of the invention. In some implementations, for client users, who have access to services only, but not to a provider's vendor management system (e.g., system 100), the rapid service delivery system may not search for contract matches. A client user may have the option to attach or upload documentation in order for service to be performed, e.g., on said documentation.

A client user may order one or more services, e.g., product-level services, e.g., a cybersecurity analysis, as described herein. FIG. 15 is an example of an order product-level service workspace in accordance with an embodiment of the invention. A client user may have options to select an order date and any rush elections by selecting the appropriate items on the workspace menu. In some implementations, the client user may be able to attach (e.g., upload from a computation device to the rapid service delivery system) relevant documentation to transmit with the order. The order form workspace may also comprise a menu to request a primary vendor contact. In some implementations, the contact list may include any contacts stored in the vendor dashboard.

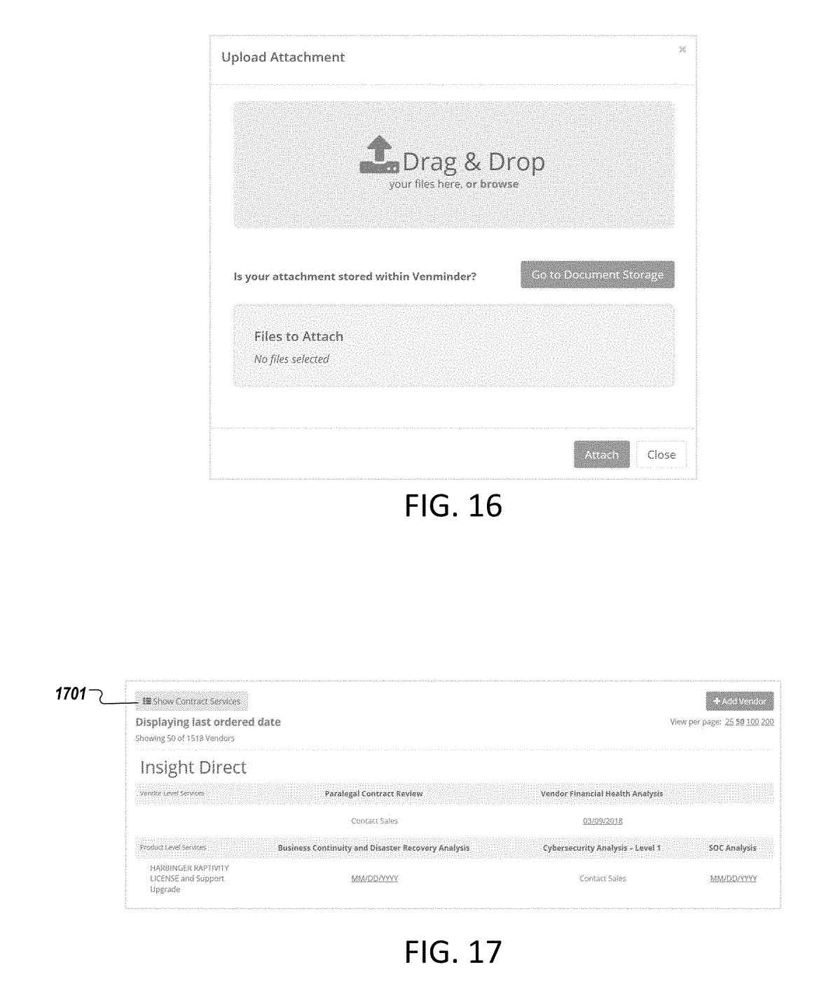

A client user may attach or upload one or more documents. FIG. 16 is an example of an attach documents dialog window in accordance with an embodiment of the invention. Clicking an attach (e.g., attach a document) button on a workspace or widget as described herein may open a dialog window wherein a client user can browse or drag-n-drop from a client user computing device. In some implementations, if the client user has access to a provider's vendor management system, the client user may also have the option to access document storage within vendor management system to retrieve the relevant document.

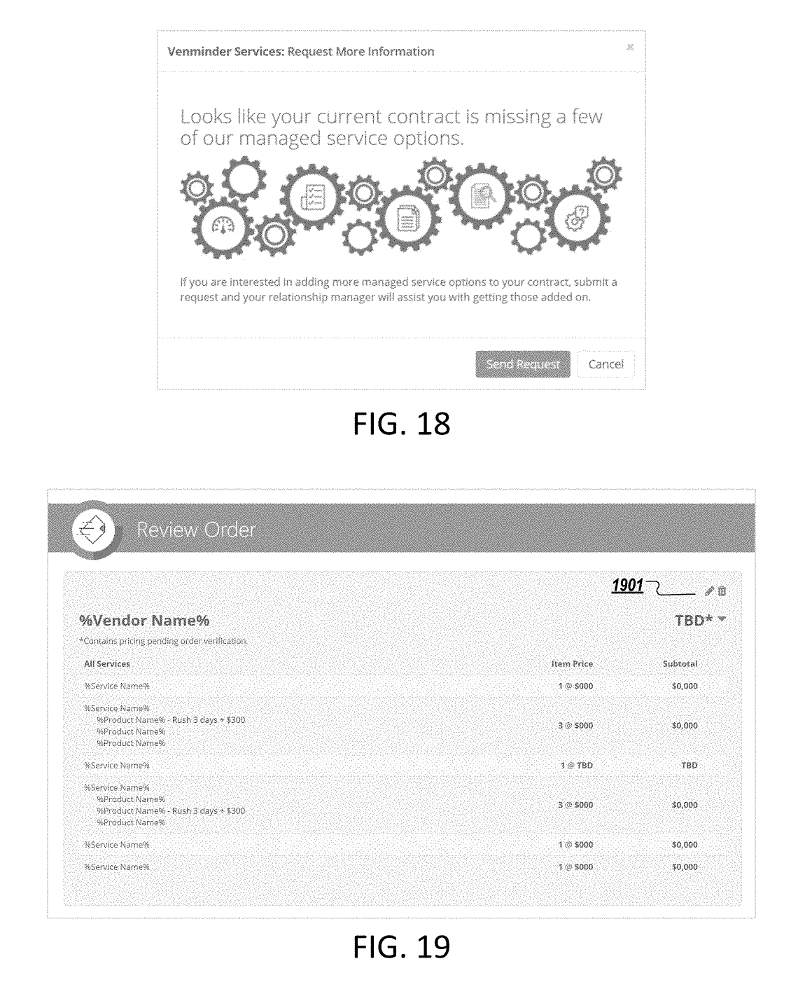

In some implementations a client user may be presented, by a rapid service delivery system, with a display window for available services. FIG. 17 is an example of a display all available services workspace in accordance with an embodiment of the invention. In some implementations, a client user may select, e.g., from a drop-down menu 1701, which services to view, e.g., selecting to show contract services. In some implementations, when a client user selects to show all services, then any of the available services that are not in a client user's purchase plan may be listed with a message, e.g. “Contact Sales” instead of last ordered date. In some implementations, the message is a link. Clicking the contact sales link may open a dialog window to request more information, e.g., regarding a rapid service delivery module. Submitting the request may cause the rapid service delivery system to send an email to the sales team. In some implementations, this email can be an existing email, which may now include service requests. FIG. 18 is an example of an information request window in accordance with an embodiment of the invention.

A client user may have the option to review one or more orders. When reviewing an order, a client user may be presented, e.g., by the rapid service delivery system, with one or more options, e.g., through a menu window, to remove a vendor and services applied from the order, review order details, and/or edit the order prior to submission. FIG. 19 is an example of a review order workspace in accordance with an embodiment of the invention.

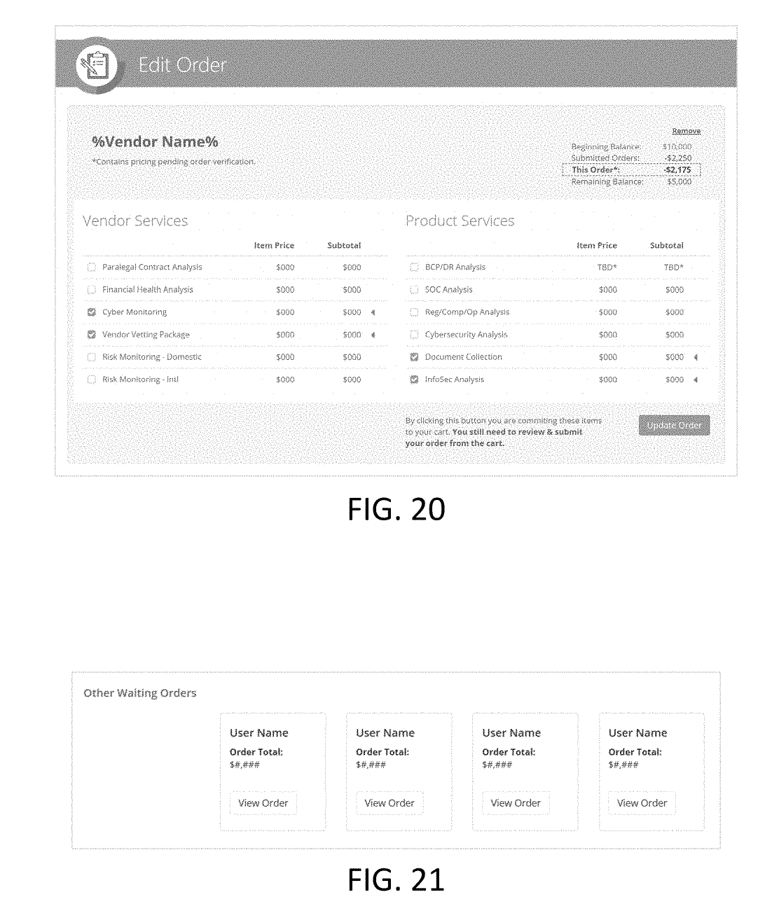

A client user may have the option to edit one or more orders, e.g., by clicking link 1901. FIG. 20 is an example of an edit order (via review order) page in accordance with an embodiment of the invention. When editing an order via the review order page, a client user may be able to add/remove/edit services as needed, prior to submission to a provider services support team.

FIG. 21 is an example of an orders in other users' carts workspace in accordance with an embodiment of the invention. If there are orders queued up in carts of other users (e.g., individual client users), their order information can be included at the bottom of the review order page. In some implementations, clicking on the View Order button in an order icon may open a dialog with details relating to that order.

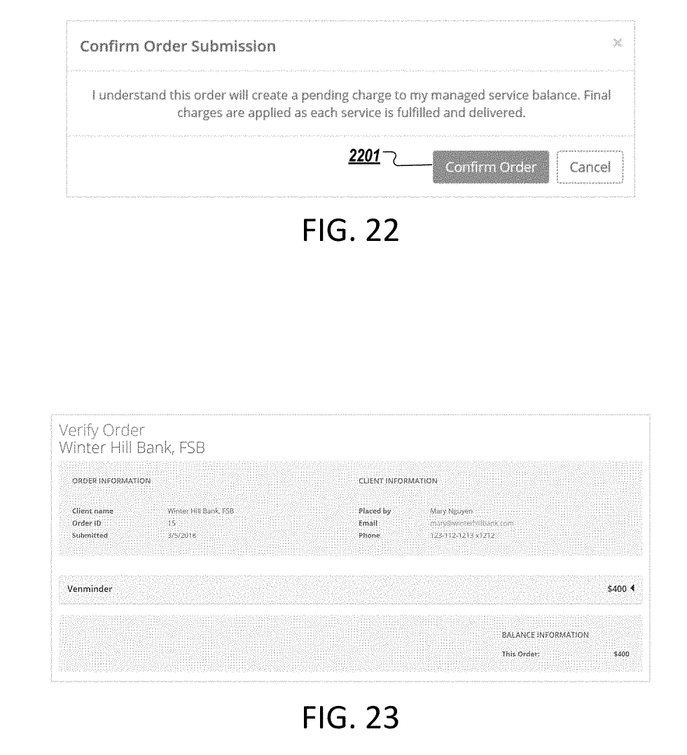

A client user may confirm and verify one or more orders. FIG. 22 is an example of a confirm order submission widget in accordance with an embodiment of the invention. When a client user selects to submit an order, the client user may be prompted by an order submission modal to confirm their action. Clicking the confirm order button 2201 may cause the order to be submitted to the system/provider services team for review and verification.

FIG. 23 is an example of an order verification workspace in accordance with an embodiment of the invention. A goal of the order verification process may be to perform an initial review of services requested by the client user. When verified, a service item may be added to the executive level analysis (ELA) Queue. This can be a portion of the system admin (internal-facing area of the application) where the system provider analysis team manages, performs and delivers the requested analysis to the client user. A system admin user may use this opportunity to made adjustments as needed to the order before handing off to a project office and/or analysis services teams for work. The workspace may allow a system admin user to review the order with a client, then make any necessary changes prior to finalizing for work, e.g., in an executive level analysis queue. When verifying an order, a client user may be presented with order information, client information, and their order selections grouped by vendor. Clicking on the vendor name may expand the window to show order information specific to the vendor.

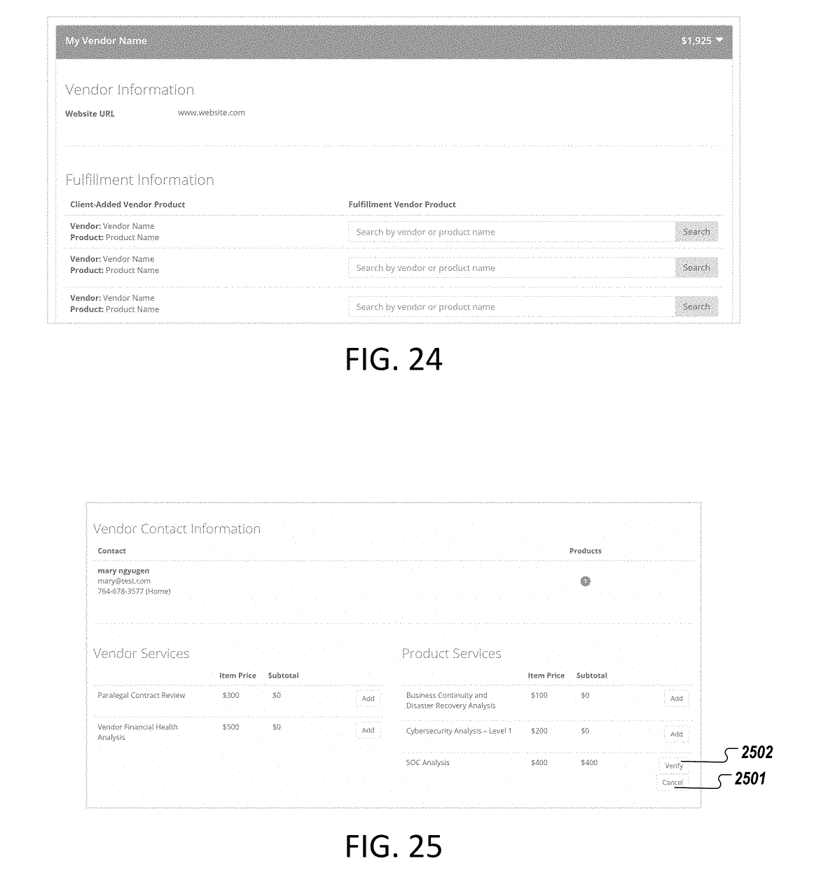

The system admin user may begin by linking a client's vendor product with a fulfillment vendor product. FIG. 24 is an example of a fulfillment vendor entry workspace in accordance with an embodiment of the invention. The link between vendor products may help a review team identify any existing work that can be re-utilized for the current order. Each vendor view may also display vendor contact information submitted by the client user, and/or a list of all available services. A system admin user can export any vendor contact information to a fulfillment vendor management page for future reference.

A client user may have the option to verify or cancel one or more ordered services. A client user may have the options to add services available but not part of a current order. FIG. 25 is an example of a verify services by vendor workspace in accordance with an embodiment of the invention. A service may be cancelled by clicking button 2501 or an verification process may be initiated by clicking verify button 2502.

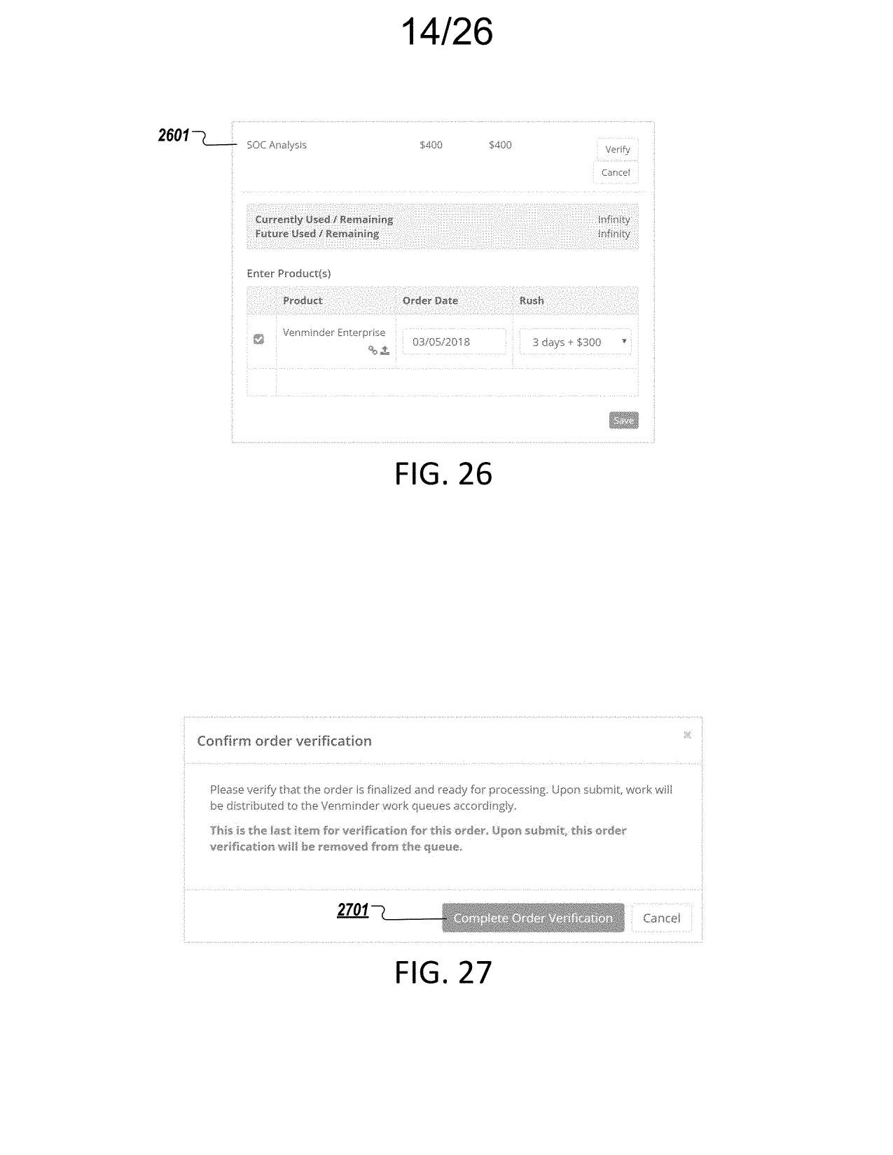

A system admin user can click on the service name to display details, as submitted by an individual user. FIG. 26 is an example of a service details display workspace in accordance with an embodiment of the invention. A verifier, e.g., a system admin user, can make adjustments to an order, e.g., as identified in service line 2601, in the same way as a client user, e.g., an individual user. In addition, the verifier may be provided with the ability to link additional products to a single order item, for example, if a single Service Organization Control (SOC) review covers multiple products. An SOC report may include documentation of a vendor's internal controls to monitor multiple areas of security: physical security, data security, and/or financial security, thus requiring multiple products. If a client user's purchase plan is itemized, additional information may be displayed to indicate current quantity usage.

A client user may have the option to verify an order. FIG. 27 is an example of a confirm order verification (dialog to confirm action to verify service) widget in accordance with an embodiment of the invention. In some implementations, when the action is confirmed, e.g., by clicking on complete order verification button 2701, the service line (e.g., service line 2601) may become read-only with a value of verified (e.g., displayed in green). At this point, that portion of the order may move to the executive level analysis queue for work. If this is the last verification for the order, upon submit, the order may be removed from the verification queue.

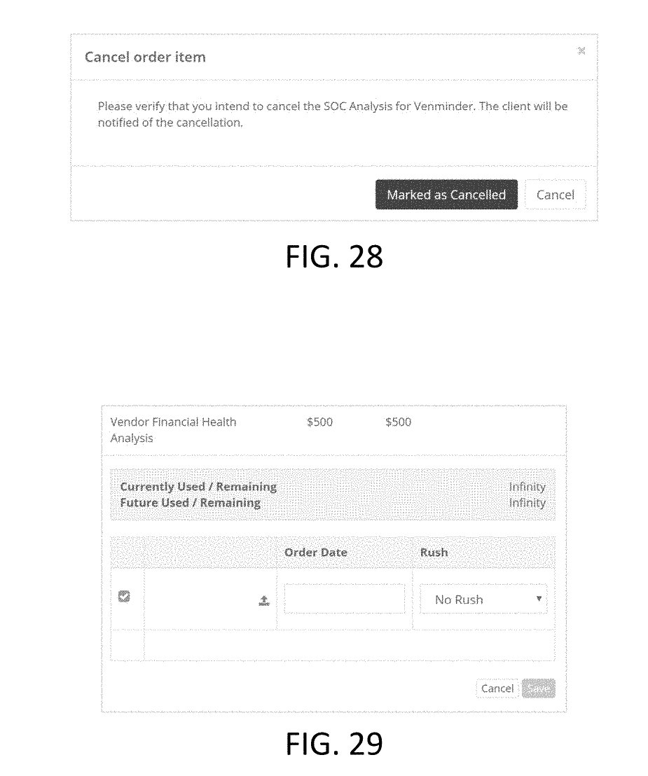

A client user may have the option to cancel an order. FIG. 28 is an example of a modal to confirm action to cancel service item widget in accordance with an embodiment of the invention. When the action is cancelled, the service line (see, e.g., FIG. 26) will become read-only with a value of cancelled (e.g., displayed in red). At this point, that portion of the order may be marked as cancelled. In some implementations, this may result in a credit to a client user account (for example a flexible account where a client has purchased a lump sum, or an itemized purchase plan. This action may also update the order status of that service line item to be cancelled.

A client user may have the option to add a service to an order. FIG. 29 is an example of an order verification—add service widget in accordance with an embodiment of the invention. Clicking on an appropriate button on a widget or page to add a service may prompt a client user with a form with the same information presented to a client user ordering a service. A client user can select the product(s), order date, and rush preference. Upon submission, a service line item may convert to a pending verification view with the option to modify order details. A client user can then verify or cancel the order.

Once an order has been verified, the order may then proceed to one or more review queues for work. As the order moves through the review process, the order status updates accordingly in the client workspace. When the order is complete, the analysis order is marked as complete and documentation is delivered to the client user's workspace, e.g., in an order history and/or document storage workspace.

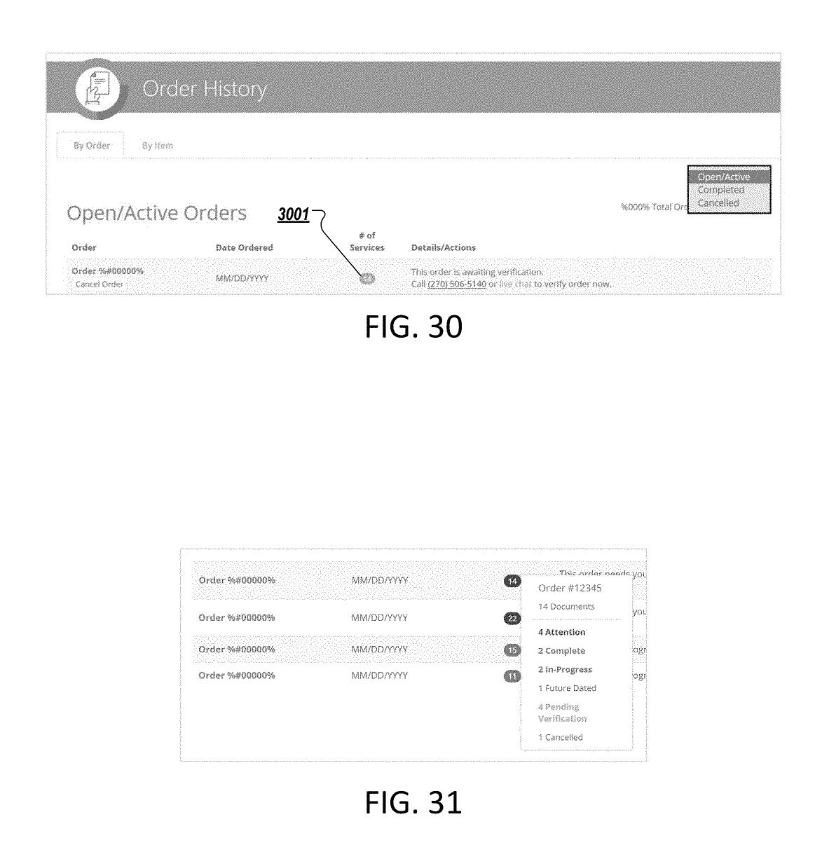

FIG. 30 is an example of an order history by order landing workspace in accordance with an embodiment of the invention. On the order history workspace, a client user may initiate one or more of the following processes: view orders by open/active, completed, or cancelled (e.g., defaulted to open/active); view by items; view and download completed orders; cancel orders in “pending verification” status; and/or view order details.

Colors may be assigned to a service quantity badge 3001 to indicate that one or more items are pending verification (e.g., yellow), require attention (e.g., red), or in progress (e.g., teal). In some implementations, the badge may become green when all services items are completed. FIG. 31 is an example of an order history status indicator widget in accordance with an embodiment of the invention.

A client user may cancel an order before work on the service begins. FIG. 32 is an example of a cancel pending order (dialog to confirm order cancellation) widget in accordance with an embodiment of the invention. In some implementations, the widget to cancel is displayed after a client user submits an order and before the first item has been verified, e.g., by the system provider support team.

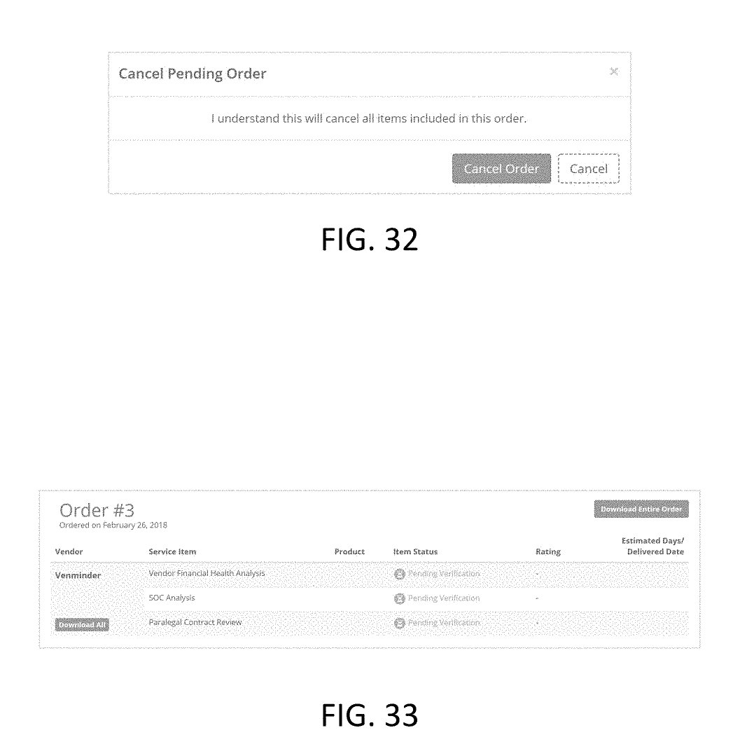

A client user may view one or more order details. FIG. 33 is an example of an order details workspace in accordance with an embodiment of the invention. In some implementations, in this workspace, a client user may download an entire order (for completed services items only); download completed items per vendor; download individual, completed services items; see the status of each item in the order; and/or change the date or cancel items in future dated orders.

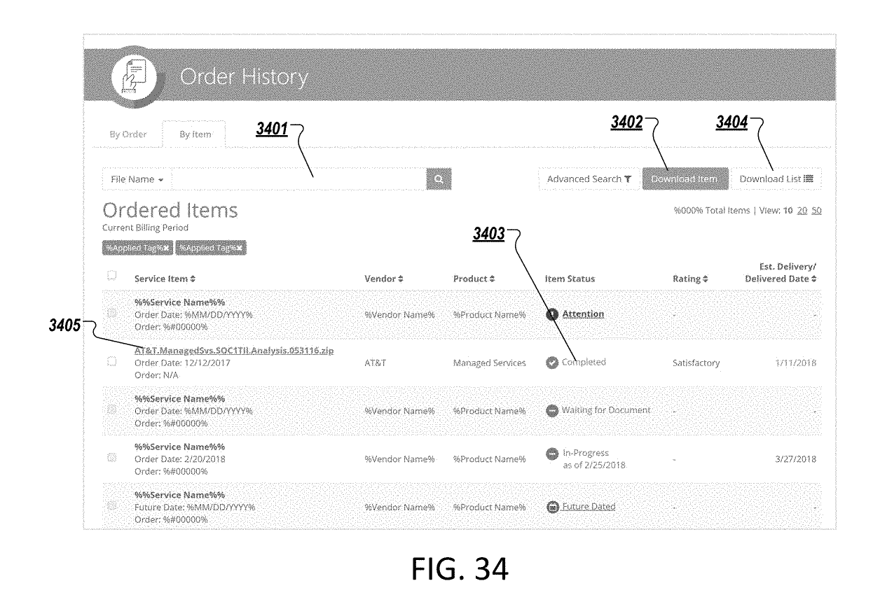

A client user may view an order history by item. FIG. 34 is an example of an order history (by item) workspace in accordance with an embodiment of the invention. When a client user views an order history by item, the workspace may display all service items within a current billing period. Each line item may include an item status, a rating, and an estimated delivery/delivered date, if applicable. For large service item lists, a client user can use a search bar 3401 to search by vendor, product, tags or file name. In some implementations, a client user can access advanced search options with multiple filters, e.g., by vendor, product, tags, item status, rating, and/or dates. A client user can select a number of service items and download them, e.g., into a ZIP file by clicking on the download item button 3402. In some implementations, this may be applicable only to completed service items, e.g., as indicated by example item status indicator 3403. Clicking on the download list button 3404 generates an spreadsheet report (e.g., a Microsoft Excel® report) of the information displayed in the by-item view. In some implementations, a service item may be or comprise a link, e.g., example line item 3405.

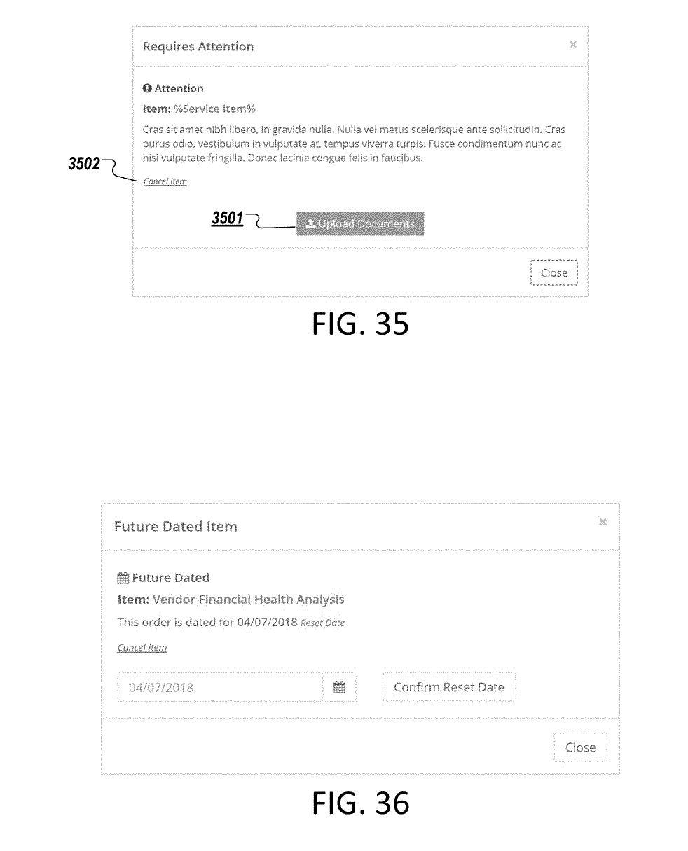

The system provider support team may initiate an attention required event to a client user, requesting more information or documentation. FIG. 35 is an example of an attention required dialog widget in accordance with an embodiment of the invention. A client user can click the status, e.g., item status indicator 3403 in the order history by item workspace, e.g., to activate the attention required dialog widget to complete the workflow, e.g. by submitting the requested items via the upload document button 3501. In some implementations, a client user may opt to cancel the item, e.g., by clicking the cancel item button 3502. This will mark the order as cancelled in both the client user and support team views.

A client user may place an order for a future date. FIG. 36 is an example of a future dated item (manage date for future-dated item) widget in accordance with an embodiment of the invention. When a client user places an order for a future date, that date may be listed, e.g., on the order history landing page. The order may be verified but may not drop into the ELA queue until the appointed date. In some implementations, when a user hovers the mouse pointer over the date, a dialog widget may be displayed that may allow a client user to change the date or cancel the item. If the client user chooses to cancel the item, when the action is confirmed, then the date or that service may return to the last order date or, e.g., to MM/DD/YYYY if that the service has not yet been ordered.

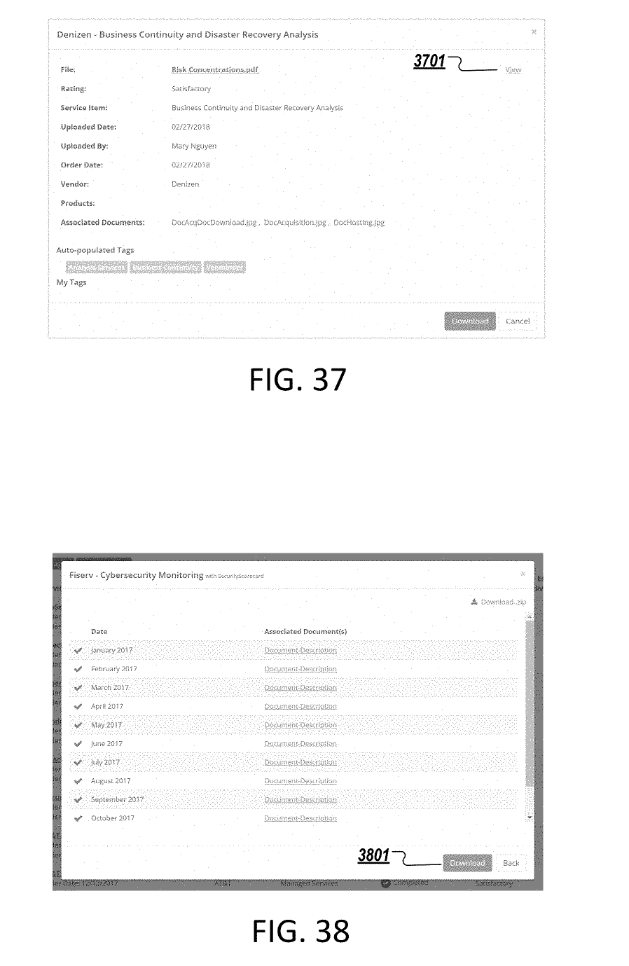

A user may view additional order information. FIG. 37 is an example of an order history—complete analysis window in accordance with an embodiment of the invention. A client user may click on a service item, e.g., link 3405, to view document details. If the analysis was performed using an in-app analysis template, the client user may click on the view link 3701 to view the analysis without requiring download.

FIG. 38 is an example of an order history—view interval service deliverables window in accordance with an embodiment of the invention. In some implementations, for services that are delivered multiple times throughout a billing period, a client user may click on a service e.g., link 3405, in the order history workspace, to review deliverables submitted to date. At any point in time, the client user may click download link 3801 to download any completed deliverable, e.g., into a ZIP file.

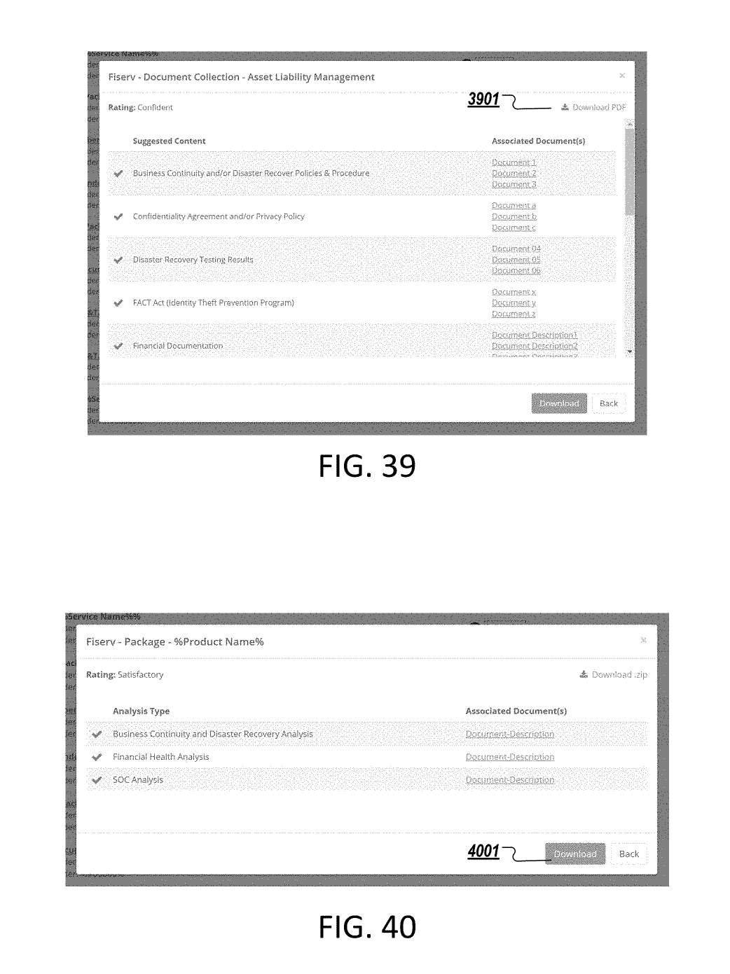

In some implementations, an order history workspace comprises a document collection link. Clicking on the document collection link may cause the display of another order history window, e.g., for a client user to view documentation that fulfills each suggested content (e.g., documents collected from a client's vendor and associated with certain document categories related to a client's compliance). FIG. 39 is an example of an order history—view document collection deliverables window in accordance with an embodiment of the invention. Clicking download PDF button 3901 may generate a copy of a content reference guide report, e.g., a report card or checklist that helps a client understand progress by the service provider in collecting compliance documentation via a document collection service.

FIG. 40 is an example of an order history—view package deliverables window in accordance with an embodiment of the invention. For package services, a client user may click on the service, e.g., link 3405, to activate an order history—view package deliverables window to view documentation that fulfills each component of the package. The user can click download zip button 4001 to download all package components into a ZIP file.

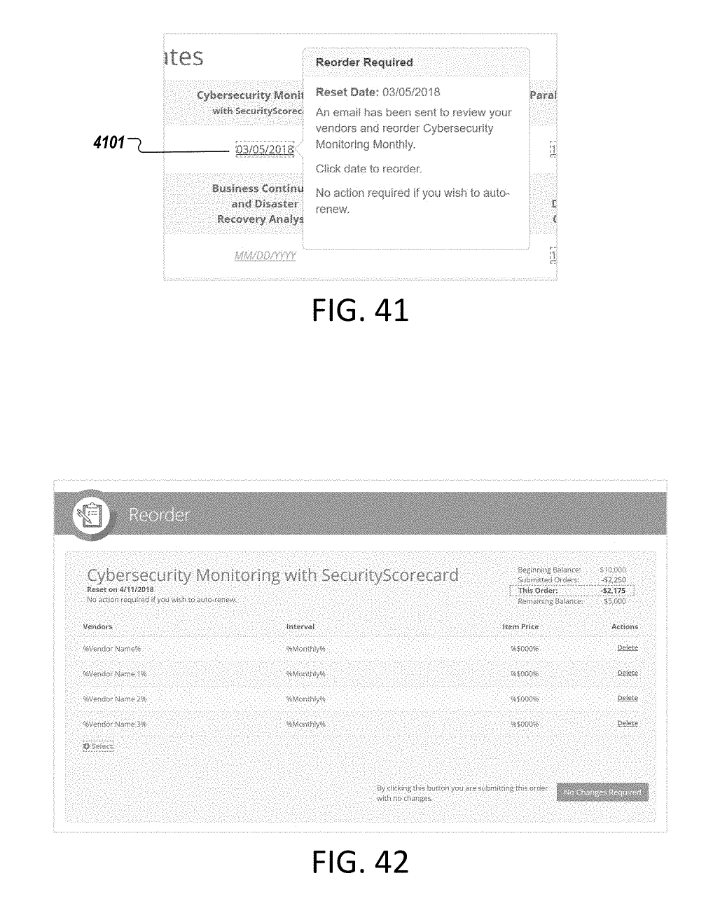

The document collection, vendor risk monitoring, and cyber monitoring (interval) services may be classified as ongoing services that persist from one billing period to another. In some implementations, e.g., 30 days prior to the start of the new billing period, a client user may be notified to review these services prior to a reset date. FIG. 41 is an example of a place order—reorder required dialog widget in accordance with an embodiment of the invention. Clicking a date link, e.g., date link 4101 may navigate the client user to the reorder page, e.g., via a place order—reorder required dialog widget, where the user may be able to review the current list of vendors linked with this service.

FIG. 42 is an example of a reorder ongoing service workspace in accordance with an embodiment of the invention. A client user can make modifications (add/delete) to the vendors as needed or indicate that no changes are required. Any changes to the list may be transmitted or otherwise made available (e.g., display via appropriate widget) to a verification team for review. If the client user indicates that no changes are required, or no action was taken before the new billing period start date, then the services may continue with the existing vendor list.

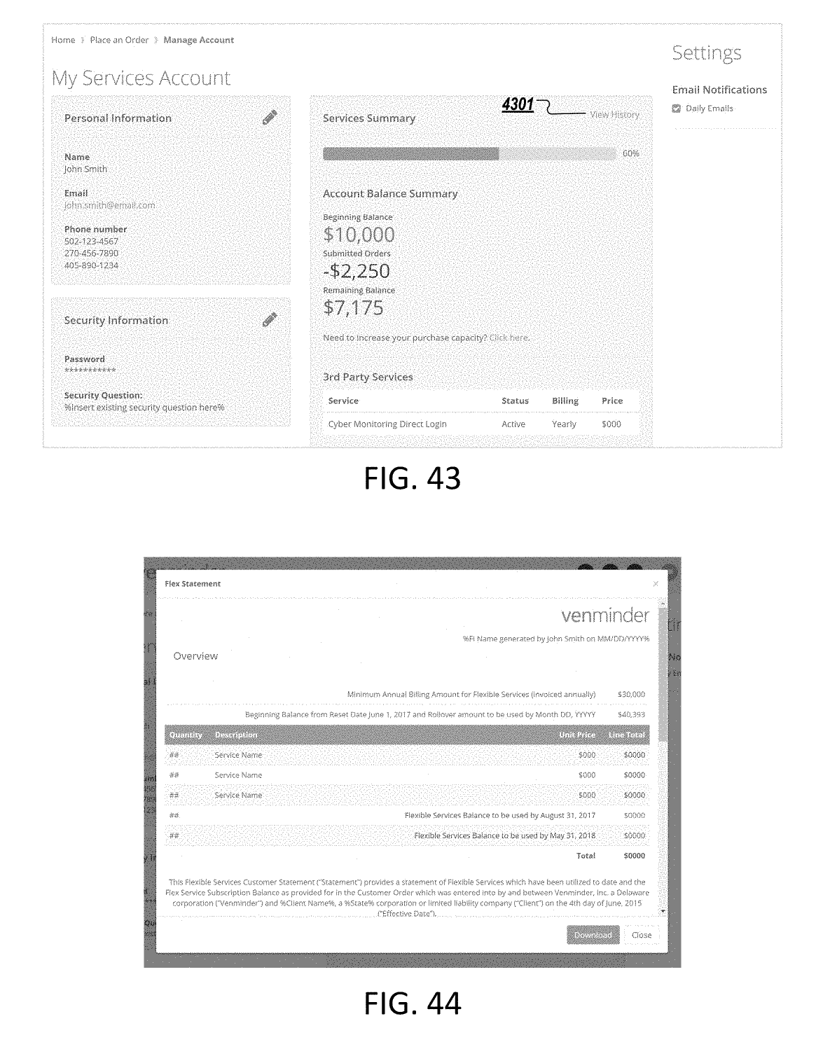

A client user may access an account page, e.g., to view client user account details. FIG. 43 is an example of a client—my account workspace in accordance with an embodiment of the invention. In some implementations, a my account page may include information pertaining to the rapid service delivery module. The service summary section can inform the client user of their current available, pending, and/or remaining balances. If the client's purchase plan includes cyber monitoring direct login service, information regarding the service may also be displayed on the page. Client users with at least the services main role may have the opportunity to opt-in to services update email notification, regardless if they are ownership of orders in that notification. Users who own orders may continue to receive relevant services update notifications regardless if they opted in or out. In some implementations, clicking on the view history link 4301 opens a dialog widget displaying a flex statement of the client's service balance and usage for the current billing period.

A flex statement may be generated using information from the client's purchase plan and deducting any orders completed to date. FIG. 44 is an example of a flex statement dialog window in accordance with an embodiment of the invention.

In some implementations, a rapid service delivery module comprises an email generator or facilitator. In some implementations, the module provides an order confirmation email. This email would be distributed to a client user who submitted an order. This email may confirm the client user's action, provide some high-level order details, and/or indicate that it is now awaiting verification. In some implementations, the module provides a services update email. This email may be distributed regularly, e.g., each day, and/or when there is a notable service event. Notable service events include when a service has been completed by a service provider team, when an order requires the user's attention, or when an order was cancelled.

In some implementations, updates are made to a due diligence rating widget, e.g., on main dashboard 202, reflecting provider service settings. Example due diligence rating widgets are explained in detail below. Examples of available scenarios are as follows, e.g., reflected in various options for a button displayed upon selection of a vendor product.

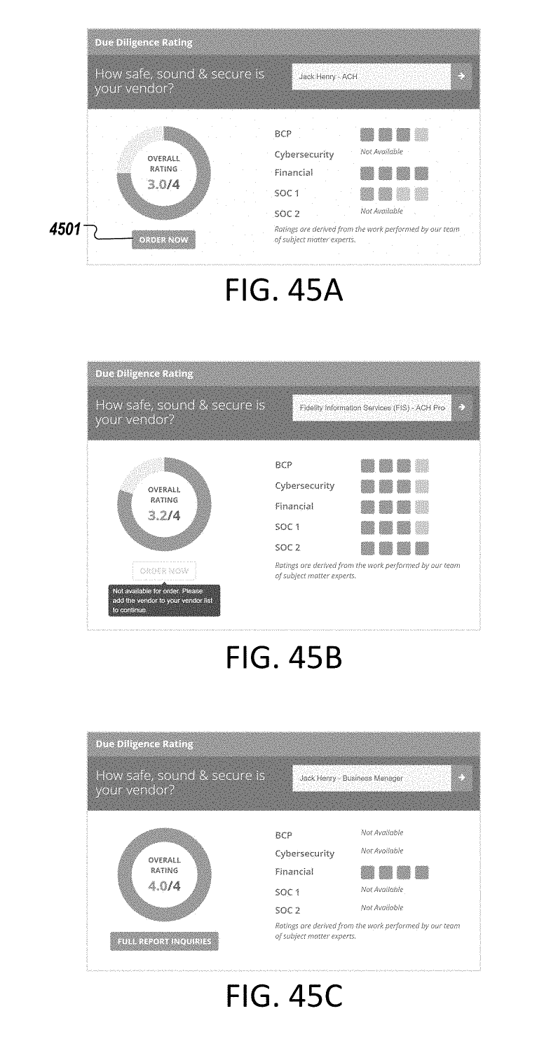

FIG. 45A is an example of a due diligence rating widget (client has the selected vendor product in their vendor list) in accordance with an embodiment of the invention. In this scenario, a client's purchase plan has one or more of the services identified in the widget. Clicking the order now button 4501 will navigate the user to provider services, e.g., a services admin panel.

FIG. 45B is another example of a due diligence rating widget (client does not have the selected vendor product in their vendor list) in accordance with an embodiment of the invention. In this scenario, a client's purchase plan does not have any of the services identified in the widget. The option to order is not available.

FIG. 45C is an example of a due diligence rating widget (client receives the option to submit to Support a services request) in accordance with an embodiment of the invention. In this scenario, a client's purchase plan does not have any of the service identified in the widget, or Client's app setting to access services portal is set to Off.

In some implementations, the system 100 provides a due diligence rating module and/or widget. Banks and credit unions are increasingly relying on third-party vendors to perform various important functions. Thus, Banks and credit unions may require high level and/or detailed (health and/or risk) analysis of a (potential) vendor, depending on a given stage of a relationship with such vendor, including financial, strategic, operational, transactional, compliance, business continuity, and/or cybersecurity health and/or risk.

A due diligence rating module provides a user with the ability to access a database comprising due diligence information (e.g., a high level and/or detailed health and/or risk analysis of a (potential) vendor). A user can look up either the user's (user/client-added) vendors and/or products, or other vendors or products (e.g., in a document collection provided by an external software and/or service provider (e.g., the provider of the system 100) to see ratings based on the results of a due diligence analysis of a vendor. In some embodiments a due diligence analysis is an analysis, e.g., in terms of a vendor's business continuity, cybersecurity, financial health, and/or service organization controls. In some embodiments, the analysis is a (most recent) executive level analysis, performed by, e.g., the external software and/or service provider, (e.g., the provider of the system 100). The due diligence rating module or widget may be especially useful, for example, when a user needs a quick, high-level assessment of ratings during a request for proposal (RFP) process prior to ordering full reports on vendor finalists.

A result of a review or analysis, provided for an executive level analysis service, can be used to calculate and/or display one or more a due diligence ratings (e.g., as a numerical value and/or as a graphical representation). In some embodiments, the due diligence rating is an overall rating. In some embodiments, the most favorable result will yield the most rating points, e.g., calculated at 4 points. An example of the result-to-point conversion is shown in Table 1:

TABLE 1

| Result | Rating Points |
|---|---|
| Confident | 4 |
| Satisfactory | 3 |
| Cautious | 2 |
| Vulnerable | 1 |

In some implementations, the due diligence rating module or widget relates to one or more areas of business continuity, cybersecurity, financial health, and/or service organization controls. Thus, the executive level analysis services that can be used for this feature can include business continuity plan analysis, cybersecurity analysis, financial analysis, or service organization controls (SOC) analysis.

To access the due diligence rating module or widget, a user (e.g., client user) logs into the system 100. The user can perform a query by vendor and/or product name by entering a search term in an appropriate data field on the due diligence rating module or widget. The user can then select a vendor and/or product, and can subsequently view available data associated with the selected vendor and/or product. In some embodiments, the user can request more information (e.g., in form of a detailed report) by submitting an application (e.g., an in-application) form. In some embodiments, the request is in form of an automatically generated email to a service provider (e.g., the provider of the system 100). In some embodiments, the request is an instruction to access a database comprising due diligence documentation, and to retrieve and provide the documentation to a user.

Example due diligence rating widgets are described in U.S. patent application Ser. No. 15/796,221, titled “Systems and Methods for Providing Vendor Management, Risk Assessment, Due Diligence, Reporting, and Custom Profiles,” filed on Oct. 27, 2017, the disclosure of which is incorporated by reference herein in its entirety.

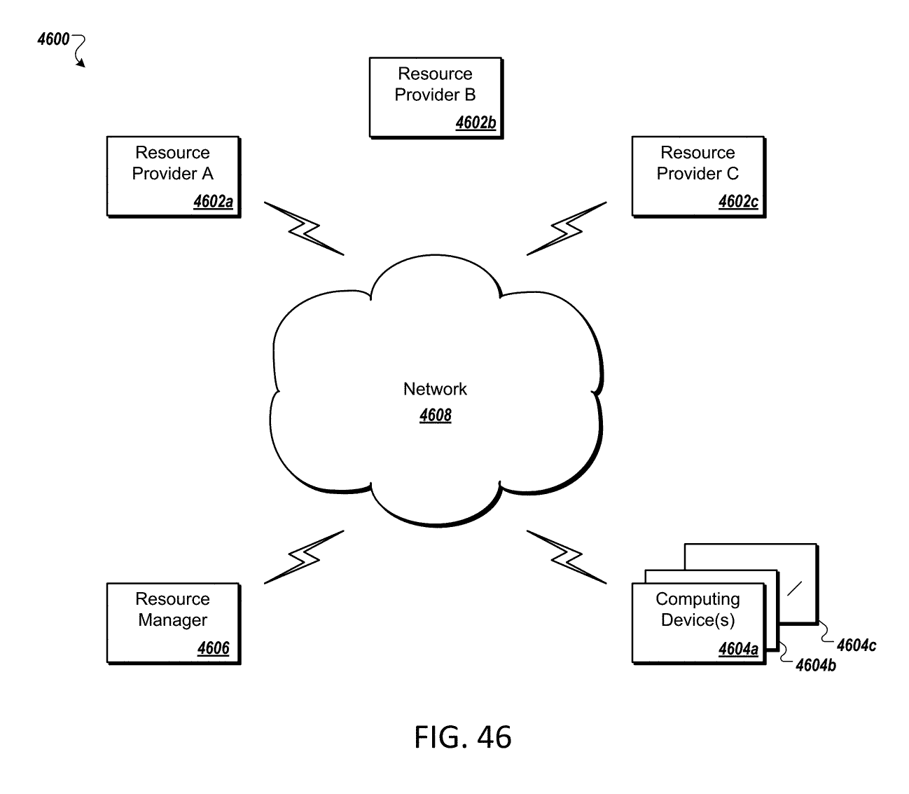

FIG. 46 shows an illustrative network environment 4600 for use in the methods and systems described herein. In brief overview, referring now to FIG. 46, a block diagram of an exemplary cloud computing environment 4600 is shown and described. The cloud computing environment 4600 may include one or more resource providers 4602a, 4602b, 4602c (collectively, 4602). Each resource provider 4602 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 4602 may be connected to any other resource provider 4602 in the cloud computing environment 4600. In some implementations, the resource providers 4602 may be connected over a computer network 4608. Each resource provider 4602 may be connected to one or more computing device 4604a, 4604b, 4604c (collectively, 4604), over the computer network 4608.

The cloud computing environment 4600 may include a resource manager 4606. The resource manager 4606 may be connected to the resource providers 4602 and the computing devices 4604 over the computer network 4608. In some implementations, the resource manager 4606 may facilitate the provision of computing resources by one or more resource providers 4602 to one or more computing devices 4604. The resource manager 4606 may receive a request for a computing resource from a particular computing device 4604. The resource manager 4606 may identify one or more resource providers 4602 capable of providing the computing resource requested by the computing device 4604. The resource manager 4606 may select a resource provider 4602 to provide the computing resource. The resource manager 4606 may facilitate a connection between the resource provider 4602 and a particular computing device 4604. In some implementations, the resource manager 4606 may establish a connection between a particular resource provider 4602 and a particular computing device 4604. In some implementations, the resource manager 4606 may redirect a particular computing device 4604 to a particular resource provider 4602 with the requested computing resource.

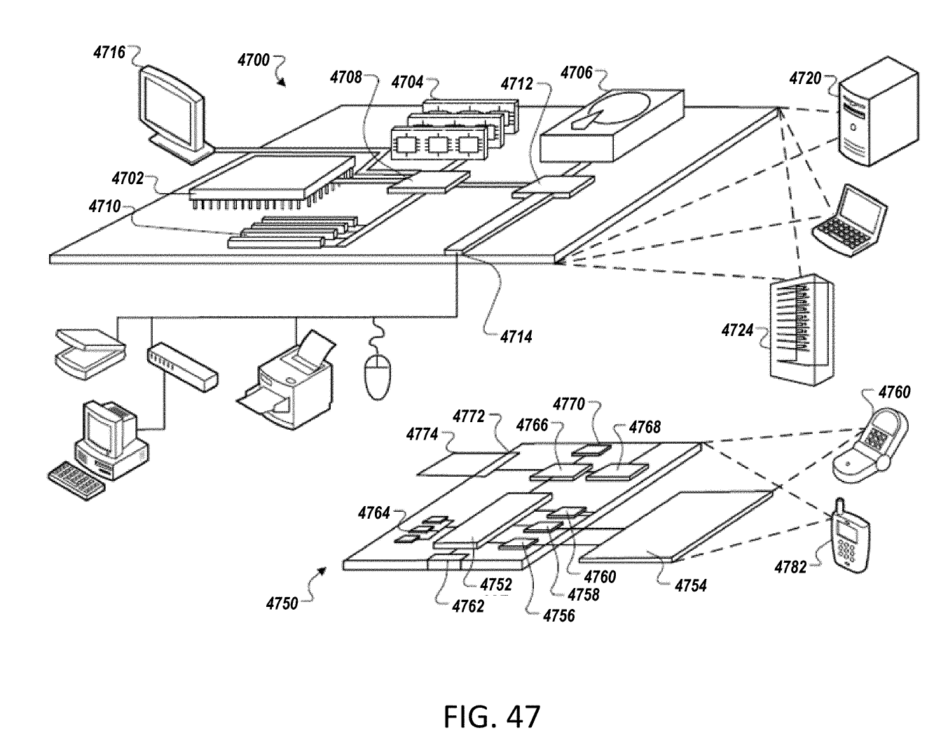

FIG. 47 shows an example of a computing device 4700 and a mobile computing device 4750 that can be used in the methods and systems described in this disclosure. The computing device 4700 is intended to represent various forms of digital computers, such as laptops, desktops, workstations, personal digital assistants, servers, blade servers, mainframes, and other appropriate computers. The mobile computing device 4750 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 4700 includes a processor 4702, a memory 4704, a storage device 4706, a high-speed interface 4708 connecting to the memory 4704 and multiple high-speed expansion ports 4710, and a low-speed interface 4712 connecting to a low-speed expansion port 4714 and the storage device 4706. Each of the processor 4702, the memory 4704, the storage device 4706, the high-speed interface 4708, the high-speed expansion ports 4710, and the low-speed interface 4712, are interconnected using various busses, and may be mounted on a common motherboard or in other manners as appropriate. The processor 4702 can process instructions for execution within the computing device 4700, including instructions stored in the memory 4704 or on the storage device 4706 to display graphical information for a GUI on an external input/output device, such as a display 4716 coupled to the high-speed interface 4708. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 4704 stores information within the computing device 4700. In some implementations, the memory 4704 is a volatile memory unit or units. In some implementations, the memory 4704 is a non-volatile memory unit or units. The memory 4704 may also be another form of computer-readable medium, such as a magnetic or optical disk.

The storage device 4706 is capable of providing mass storage for the computing device 4700. In some implementations, the storage device 4706 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 4702), perform one or more methods, such as those described above. The instructions can also be stored by one or more storage devices such as computer- or machine-readable mediums (for example, the memory 4704, the storage device 4706, or memory on the processor 4702).

The high-speed interface 4708 manages bandwidth-intensive operations for the computing device 4700, while the low-speed interface 4712 manages lower bandwidth-intensive operations. Such allocation of functions is an example only. In some implementations, the high-speed interface 4708 is coupled to the memory 4704, the display 4716 (e.g., through a graphics processor or accelerator), and to the high-speed expansion ports 4710, which may accept various expansion cards (not shown). In the implementation, the low-speed interface 4712 is coupled to the storage device 4706 and the low-speed expansion port 4714. The low-speed expansion port 4714, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 4700 may be implemented in a number of different forms, as shown in the figure. For example, it may be implemented as a standard server 4720, or multiple times in a group of such servers. In addition, it may be implemented in a personal computer such as a laptop computer 4722. It may also be implemented as part of a rack server system 4724. Alternatively, components from the computing device 4700 may be combined with other components in a mobile device (not shown), such as a mobile computing device 4750. Each of such devices may contain one or more of the computing device 4700 and the mobile computing device 4750, and an entire system may be made up of multiple computing devices communicating with each other.

The mobile computing device 4750 includes a processor 4752, a memory 4764, an input/output device such as a display 4754, a communication interface 4766, and a transceiver 4768, among other components. The mobile computing device 4750 may also be provided with a storage device, such as a micro-drive or other device, to provide additional storage. Each of the processor 4752, the memory 4764, the display 4754, the communication interface 4766, and the transceiver 4768, are interconnected using various buses, and several of the components may be mounted on a common motherboard or in other manners as appropriate.

The processor 4752 can execute instructions within the mobile computing device 4750, including instructions stored in the memory 4764. The processor 4752 may be implemented as a chipset of chips that include separate and multiple analog and digital processors. The processor 4752 may provide, for example, for coordination of the other components of the mobile computing device 4750, such as control of user interfaces, applications run by the mobile computing device 4750, and wireless communication by the mobile computing device 4750.

The processor 4752 may communicate with a user through a control interface 4758 and a display interface 4756 coupled to the display 4754. The display 4754 may be, for example, a TFT (Thin-Film-Transistor Liquid Crystal Display) display or an OLED (Organic Light Emitting Diode) display, or other appropriate display technology. The display interface 4756 may comprise appropriate circuitry for driving the display 4754 to present graphical and other information to a user. The control interface 4758 may receive commands from a user and convert them for submission to the processor 4752. In addition, an external interface 4762 may provide communication with the processor 4752, so as to enable near area communication of the mobile computing device 4750 with other devices. The external interface 4762 may provide, for example, for wired communication in some implementations, or for wireless communication in other implementations, and multiple interfaces may also be used.

The memory 4764 stores information within the mobile computing device 4750. The memory 4764 can be implemented as one or more of a computer-readable medium or media, a volatile memory unit or units, or a non-volatile memory unit or units. An expansion memory 4774 may also be provided and connected to the mobile computing device 4750 through an expansion interface 4772, which may include, for example, a SIMM (Single In Line Memory Module) card interface. The expansion memory 4774 may provide extra storage space for the mobile computing device 4750, or may also store applications or other information for the mobile computing device 4750. Specifically, the expansion memory 4774 may include instructions to carry out or supplement the processes described above, and may include secure information also. Thus, for example, the expansion memory 4774 may be provided as a security module for the mobile computing device 4750, and may be programmed with instructions that permit secure use of the mobile computing device 4750. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 4752), perform one or more methods, such as those described above. The instructions can also be stored by one or more storage devices, such as one or more computer- or machine-readable mediums (for example, the memory 4764, the expansion memory 4774, or memory on the processor 4752). In some implementations, the instructions can be received in a propagated signal, for example, over the transceiver 4768 or the external interface 4762.

The mobile computing device 4750 may communicate wirelessly through the communication interface 4766, which may include digital signal processing circuitry where necessary. The communication interface 4766 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 4768 using a radio-frequency. In addition, short-range communication may occur, such as using a Bluetooth®, Wi-Fi™, or other such transceiver (not shown). In addition, a GPS (Global Positioning System) receiver module 4770 may provide additional navigation- and location-related wireless data to the mobile computing device 4750, which may be used as appropriate by applications running on the mobile computing device 4750.

The mobile computing device 4750 may also communicate audibly using an audio codec 4760, which may receive spoken information from a user and convert it to usable digital information. The audio codec 4760 may likewise generate audible sound for a user, such as through a speaker, e.g., in a handset of the mobile computing device 4750. Such sound may include sound from voice telephone calls, may include recorded sound (e.g., voice messages, music files, etc.) and may also include sound generated by applications operating on the mobile computing device 4750.

The mobile computing device 4750 may be implemented in a number of different forms, as shown in the figure. For example, it may be implemented as a cellular telephone 4780. It may also be implemented as part of a smart-phone 4782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Components of different implementations described in this specification may be combined to form other implementations not specifically set forth in this specification. Components may be left out of the systems, computer programs, databases, etc. described in this specification without adversely affecting their operation. In addition, the logic flows shown in, or implied by, the figures do not require the particular order shown, or sequential order, to achieve desirable results. Various separate components may be combined into one or more individual components to perform the functions described here.

What is claimed:

1. A computer implemented method for managing service orders relating to contracts between a financial institution and its vendors, the method comprising the steps of:
causing to display, by a processor of an enterprise system, a first graphical user interface (GUI) associated with a rapid service delivery module;
receiving, by the processor, a first input from a first client user, the first input comprising instructions to select the rapid service delivery module;
causing to display, by a processor, a second GUI associated with one or more service products;
receiving, by the processor, a second input from the first client user, the second input comprising instructions to select one of the one or more services, thereby placing an order for the one of the one or more services; and
updating, in a memory of the enterprise system, information relating to the selected service product in association with the first client, based on the second input.

2. The method of claim 1, wherein the first client user has been authorized to access the enterprise system.

3. The method of claim 1, wherein the first client user is a member of a network of subscribed clients.

4. The method of claim 1, comprising:
causing to display, by the processor, a workspace GUI, wherein a subsequent input comprises custom data field information, the custom data field information comprising information relating to one or more selectable electronic files;
receiving, by the processor, custom data filed information relating to the one or more selectable electronic files thereby selecting one of the one or more selectable files; and
transferring, by the processor, the one or more selected electronic files from a client user device to the enterprise system.

5. The method of claim 4, wherein the workspace GUI is an attach documents dialog window GUI.

6. The method of claim 1, comprising:
causing to display, by the processor, a first workspace GUI, wherein a subsequent input comprises instructions to initiate an order verification process or a cancellation process.

7. The method of claim 6, wherein the workspace GUI is a verify services by vendor GUI.

8. The method of claim 6, comprising:
causing to display, by the processor, upon instruction by a user to initiate an order verification process of an order, a second workspace GUI, wherein a subsequent input comprises instructions to complete an order verification process.

9. The method of claim 8, wherein the instruction comprises clicking a button on a GUI, and wherein the second GUI is a complete order verification GUI.

10. The method of claim 6, comprising:
causing to display, by the processor, upon instruction by a user to cancel an order, a third workspace GUI, wherein a subsequent input comprises instructions to cancel a service process.

11. The method of claim 10, wherein the instruction comprises clicking a button on a GUI, and wherein the second GUI is a confirm action to cancel GUI.

12. The method of claim 1, comprising:
causing to display, by the processor, a first workspace GUI, wherein a subsequent input comprises instructions to open a workspace to input custom data field information, the custom data field information relating to additional information required to process an order.

13. The method of claim 12, wherein the GUI is an order history GUI.

14. The method of claim 12, comprising:
causing to display, by the processor, a second workspace GUI (e.g., attention required dialog widget), wherein a subsequent input comprises custom data field information, the custom data field information comprising file information;
receiving, by the processor, custom data filed information relating to one or more selected electronic files; and
transferring, by the processor, the one or more selected electronic files from a client user device to the enterprise system.

15. The method of claim 12, wherein the GUI is or comprises an attention required dialog widget.

16. The method of claim 1, comprising:
causing to display, by the processor, a workspace GUI (e.g., view document collection deliverables window GUI), wherein a subsequent input comprises, upon completion of an order, instructions to open a workspace to download one or more electronic documents from the enterprise system to a client computing device.

17. The method of claim 16, wherein the GUI is a view document collection deliverables window GUI.
